(19) United States
(12) Patent Application Publication
(10) Pub. No.: US 2017/0285386 A1
(43) Pub. Date: Oct. 5, 2017

(54) DISPLAY DEVICE

(71) Applicant: Panasonic Liquid Crystal Display Co., Ltd., Hyogo (JP)

(72) Inventor: Kikuo ONO, Ibaraki (JP)

(21) Appl. No.: 15/085,231

(22) Filed: Mar. 30, 2016

(51) Int. Cl. G02F 1/1339; G02F 1/1362; G02F 1/1337; G02F 1/1343; G02F 1/1368; G02F 1/1335

(52) U.S. Cl. CPC G02F 1/13394; G02F 1/1368; G02F 1/133514; G02F 1/133512; G02F 1/13378; G02F 1/134336; G02F 1/136286; G02F 2001/133302

(57) ABSTRACT

A liquid crystal display device includes a first substrate, a second substrate, a liquid crystal layer and a plurality of spacers. A display region of the first substrate includes a thin film transistor, a reflective electrode, a light-shielding layer and a color filter. A display region of the second substrate includes a second alignment layer. The plurality of spacers is integrally formed in the first substrate.

### TECHNICAL FIELD

The present disclosure relates to a display device and a production method thereof.

### BACKGROUND

### Summary

An object of the present disclosure is to provide a display device and a production method thereof, for being able to enlarge an alignment margin for upper and lower substrates, preferably for a curved display and a flexible display.

The configuration of the display device according to the present disclosure can enlarge the alignment margin for upper and lower substrates, preferably for a curved display and a flexible display.

### BRIEF DESCRIPTION OF DRAWINGS

FIG. 1 is a block diagram of an example of a system configuration of a liquid crystal display device according to a first embodiment;

FIG. 2 is a circuit diagram of a drive circuit that drives pixels of the liquid crystal display device according to the first embodiment;

FIG. 3 is a plan view illustrating a pixel including three sub-pixels in the liquid crystal display device according to the first embodiment;

FIG. 4 is a schematic diagram of a cross-section taken along line 4-4′ in FIG. 3;

FIG. 5 is a schematic diagram of a cross-section taken along line 5-5′ in FIG. 3;

FIG. 6 is a schematic diagram of a cross-section taken along line 6-6′ in FIG. 3;

FIG. 7 is a schematic diagram of a cross-section taken along line 7-7′ in FIG. 3;

FIG. 8A is a schematic diagram of a cross-section of the second substrate taken along a line 8-8′ in FIG. 8B;

FIG. 8B is a bottom plan view of the second substrate in the liquid crystal display device according to the first embodiment;

FIG. 9A is a schematic diagram of a partial cross-section of a second substrate taken along a line 9-9′ in FIG. 9B;

FIG. 9B is a partial bottom plan view of a second substrate in a comparative example of a liquid crystal display device;

FIG. 10 is a schematic diagram of a cross-section taken along line 7-7′ in FIG. 3 after a first step of a manufacturing process;

FIG. 11 is a schematic diagram of a cross-section taken along line 7-7′ in FIG. 3 after a second step of a manufacturing process;

FIG. 12 is a schematic diagram of a cross-section taken along line 7-7′ in FIG. 3 after a third step of a manufacturing process;

FIG. 13 is a schematic diagram of a cross-section taken along line 7-7′ in FIG. 3 after a fourth step of a manufacturing process;

FIG. 14 is a schematic diagram of a cross-section taken along line 7-7′ in FIG. 3 after a fifth step of a manufacturing process;

FIG. 15 is a schematic diagram of a cross-section taken along line 7-7′ in FIG. 3 after a sixth step of a manufacturing process;

FIG. 16 is a schematic diagram of a cross-section taken along line 7-7′ in FIG. 3 after a seventh step of a manufacturing process;

FIG. 17 is a schematic diagram of a cross-section taken along line 7-7′ in FIG. 3 after an eighth step of a manufacturing process;

FIG. 18 is a schematic diagram of a cross-section taken along line 7-7′ in FIG. 3 after a ninth step of a manufacturing process;

FIG. 19 is a schematic diagram of a cross-section taken along line 7-7′ in FIG. 3 after a tenth step of a manufacturing process;

FIG. 20 is a schematic diagram of a cross-section taken along line 7-7′ in FIG. 3 after an eleventh step of a manufacturing process;

FIG. 21 is a schematic diagram of a cross-section taken along line 7-7′ in FIG. 3 after a twelfth step of a manufacturing process;

FIG. 22 is a schematic diagram of a cross-section taken along line 7-7′ in FIG. 3 after a thirteenth step of a manufacturing process;

FIG. 23 is a schematic diagram of a cross-section taken along line 7-7′ in FIG. 3 after a fourteenth step of a manufacturing process;

FIG. 24 is a plan view illustrating a pixel including three sub-pixels in the liquid crystal display device according to a second embodiment;

FIG. 25 is a schematic diagram of a cross-section taken along line 25-25′ in FIG. 24;

FIG. 26 is a schematic diagram of a cross-section taken along line 26-26′ in FIG. 24;

FIG. 27 is a plan view illustrating a pixel including three sub-pixels in the liquid crystal display device according to a third embodiment;

FIG. 28 is a schematic diagram of a cross-section taken along line 28-28′ in FIG. 27;

FIG. 29 is a schematic diagram of a cross-section taken along line 29-29′ in FIG. 27;

FIG. 30 is a plan view illustrating a pixel including four sub-pixels in the liquid crystal display device according to a fourth embodiment;

FIG. 31 is a schematic diagram of a cross-section taken along line 31-31′ in FIG. 30;

FIG. 32 is a plan view illustrating a pixel including three sub-pixels in the liquid crystal display device according to a fifth embodiment;

FIG. 33 is a schematic diagram of a cross-section taken along line 33-33′ in FIG. 32;

FIG. 34 is a schematic diagram of a cross-section taken along line 34-34′ in FIG. 32.

### DETAILED DESCRIPTION OF THE PREFERRED EMBODIMENTS

Hereinafter, exemplary embodiments of the present disclosure will be described with reference to the drawings. A liquid crystal display device is described below by way of example. However, a display device according to the present disclosure is not limited to the liquid crystal display device, but may be an organic EL display device and the like.

### First Embodiment

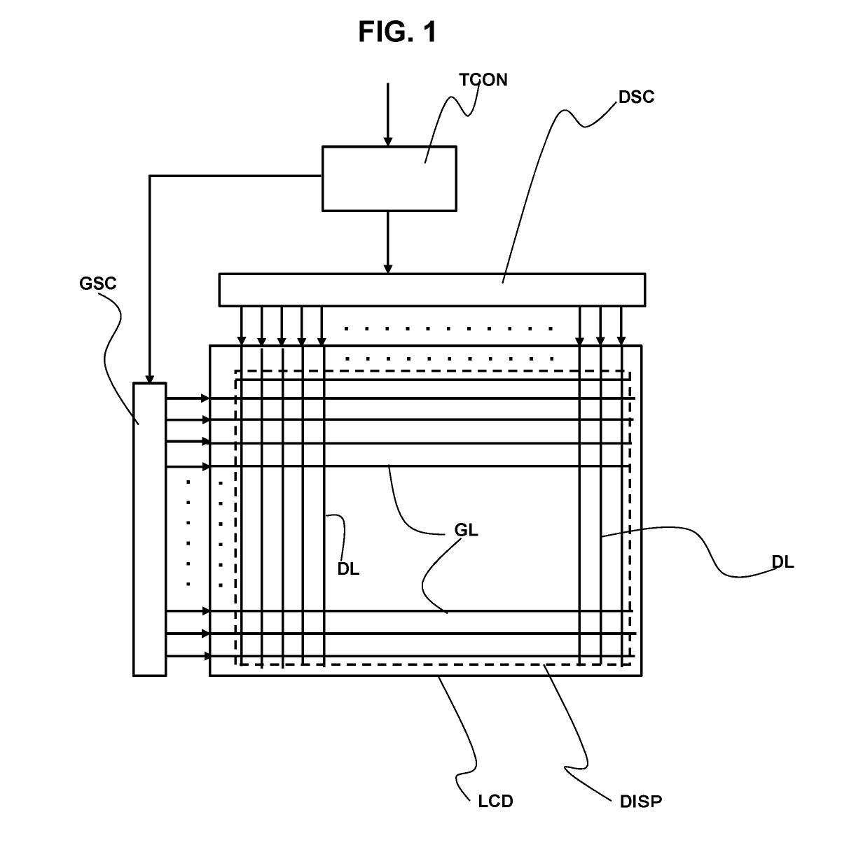

FIG. 1 illustrates a liquid crystal display device including a liquid crystal display LCD, a timing control circuit TCON, a gate scanning drive circuit GSC and a data signal drive circuit DSC. The timing control circuit TCON receives an outside image signal and, based on the image signal, outputs a data signal and a timing signal to both the gate scanning drive circuit GSC and the data signal drive circuit DSC. In the liquid crystal display LCD, gate lines GL are scanned by the gate scanning drive circuit GSC and a data voltage based on the image signal is supplied to data lines DL from the data signal drive circuit DSC. The gate lines GL are formed in a display region DISP, and extend in a horizontal direction and are arrayed in a vertical direction. The data lines DL are formed in the display region DISP, and extend in the vertical direction and are arrayed in the horizontal direction. The gate scanning drive circuits GSC and the data signal drive circuits DSC can be manufactured in the same process of thin film transistors (TFTs) within the display region DISP.

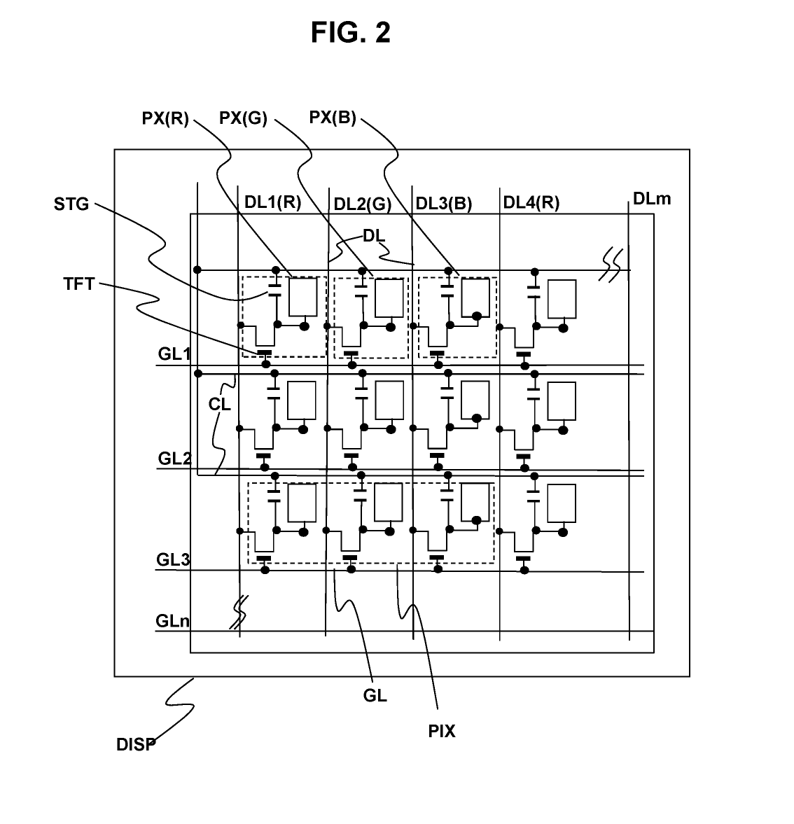

Active matrix display is performed in each pixel PIX. Specifically, as illustrated in FIG. 2, a gate voltage is supplied from the gate scanning drive circuit GSC through gate lines GL1, GL2, . . . and GLn and the data voltage is supplied from the data signal drive circuit DSC through data lines DL1, DL2, . . . and DLm. Pixels PIX are arranged in a matrix in the display region DISP. As illustrated in FIG. 2, one pixel PIX in this embodiment includes three sub-pixels in which color filters of red, green and blue are formed, respectively. In FIG. 2, one sub-pixel PX is defined by two adjacent gate lines GL and two adjacent data lines DL. The thin film transistor (TFT) and a pixel electrode PIT, which is connected to the TFT, are formed in the sub-pixel PX. The pixel electrode PIT is constituted of a rectangular layer corresponding to each sub-pixel. A common electrode CIT is formed opposite to the pixel electrode PIT. The common electrode CIT is formed into a flat shape in the whole of the display region DISP. In each sub-pixel PX region of the common electrode CIT, an opening is formed in a region where a contact hole CONT and a part (source electrode) of thin film transistor TFT are formed in plan view. The common electrode CIT covers the data line DL and the gate line GL to act as a shield electrode. Therefore, for example, an electric field noise generated from the data line DL and the gate line GL can be prevented from entering the liquid crystal layer LC.

Common metal lines CL are formed so as to electrically connect to the common electrode CIT in order to assist to provide a common voltage with the common electrode. The common metal lines CL are not essential components, especially for a small display which does not require high power of providing the common voltage. A common electrode CIT may be formed in each sub-pixel separately. In this case, common metal lines have a function of connecting plural common electrodes CIT with each other. The pixel electrode PIT and the common electrode CIT are made of a transparent conductive material, such as Indium-Tin-Oxide (ITO). The thin film transistor TFT is turned on and off to control the feeding of the data voltage to the pixel electrode PIT formed in the sub-pixel PX. Then, by an electric field generated between a common voltage supplied from a common electrode drive circuit via a common metal line CL to the common electrode CIT and the data voltage supplied to the pixel electrode PIT, a liquid crystal layer LC is driven. In order to prevent a voltage drop in the liquid crystal layer LC, a holding capacitance STG is formed in each sub-pixel PX. When a color display is performed, it is realized by applying a data voltage to the data lines DL1 (R), DL2 (G) and DL3 (B) connected to the sub-pixels PX of red, green and blue, respectively, which are each formed with a vertical striped color filter.

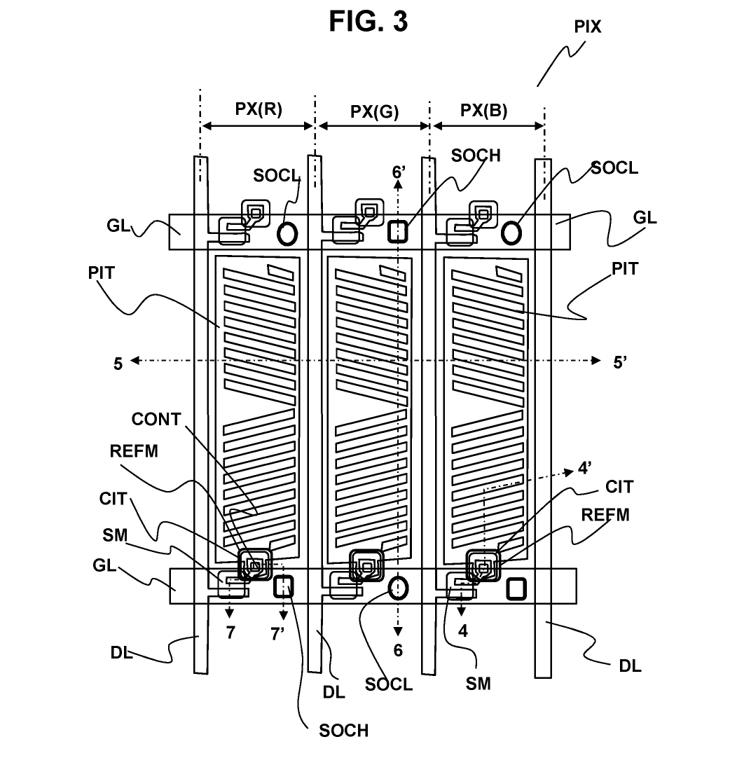

As illustrated in FIG. 3, one pixel PIX is comprised of three sub-pixels PX having color filters of different colors. The sub-pixels PX in one pixel PIX include a red sub-pixel region PX (R) having a red color filter, a green sub-pixel region PX (G) having a green color filter and a blue sub-pixel region PX (B) having a blue color filter. The sub-pixel PX includes a gate line GL, a data line DL, a semiconductor layer SEM, a source electrode SM, a pixel electrode PIT, a common electrode CIT and a reflective electrode REFM. The pixel electrode PIT is connected to the source electrode SM through a through-hole portion CONT of insulation films. As the liquid crystal display LCD according to the first embodiment is a reflective liquid crystal display, each sub-pixel PX has the reflective electrode REFM. Sunlight, natural light in a room or an LED light from an equipped front light from outside enters the display region DISP and is reflected on the reflective electrode REFM. A gray scale is controlled by a liquid crystal layer LC. The reflective electrode REFM is made of a high reflective material, such as aluminum (Al) or silver (Ag). The liquid crystal display LCD includes two substrates, a first substrate, so-called a TFT substrate, and a second substrate opposite to the first substrate, and the liquid crystal layer LC sandwiched between the two substrates. Positive-type liquid crystal molecules in which major axes are aligned along an electric field direction are sealed in the liquid crystal layer LC. Negative-type liquid crystal molecules in which major axes are aligned to be perpendicular with an electric field direction may be used. Spaces are formed between the two substrates to maintain a gap between them. According to the first embodiment, there are two kinds of spacers, including a high gap spacer SOCH and a low gap spacer SOCL. Their functions will be explained later. These spacers SOCH and SOCL are formed in gate lines GL. According to the first embodiment, either the high gap spacer SOCH or the low gap spacer SOCL is formed between two sub-pixels. And the high gap spacer SOCH and the low gap spacer SOCL are formed alternatively in the horizontal direction and the vertical direction. A known configuration can be used in the spacers.

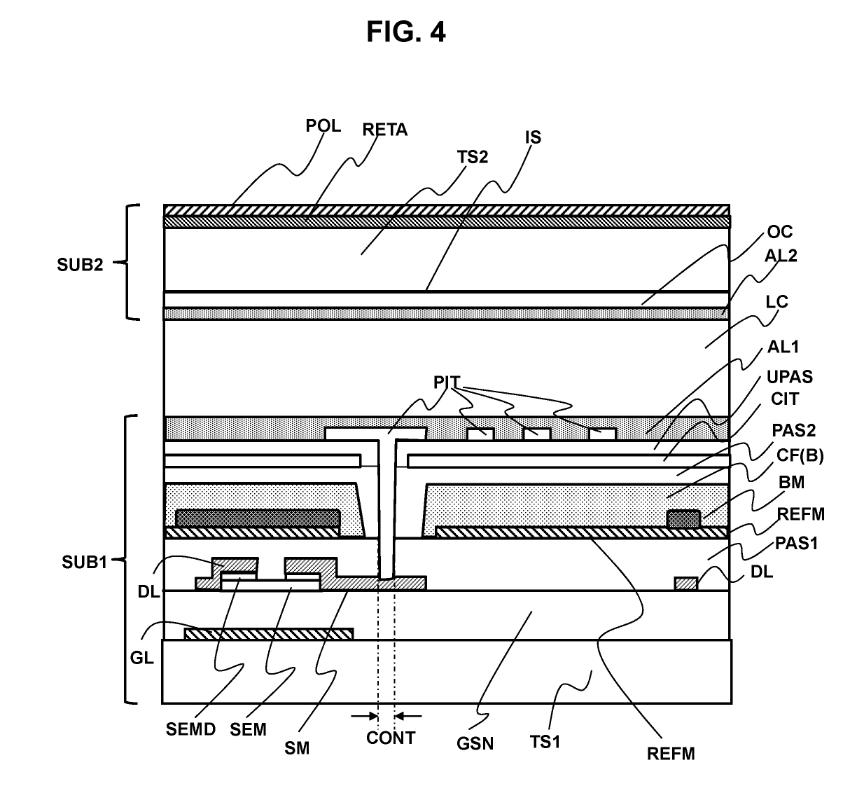

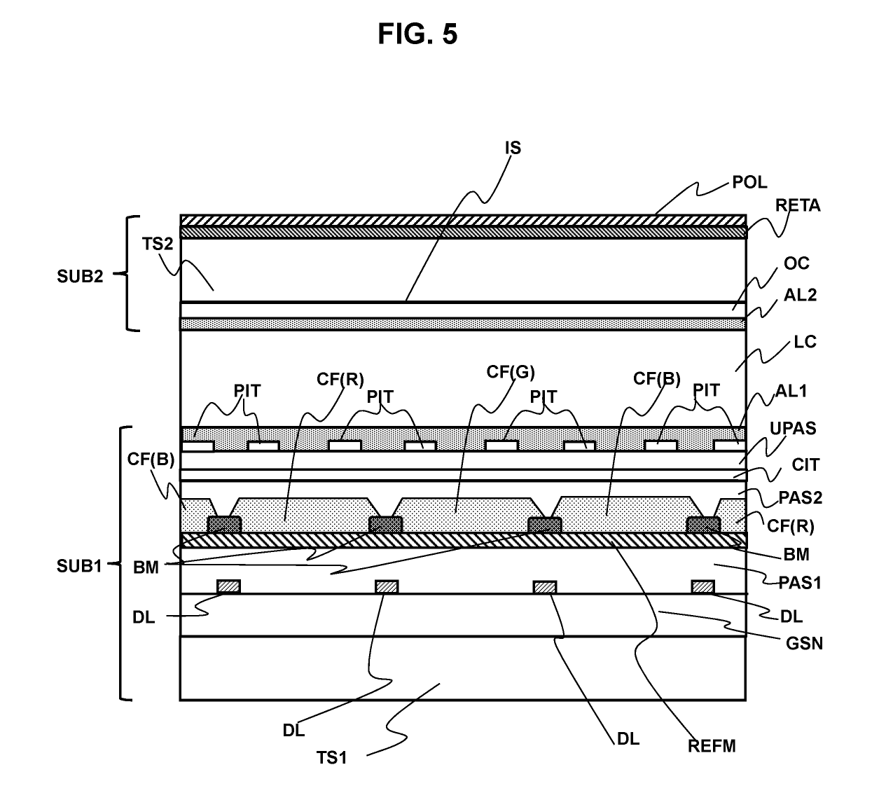

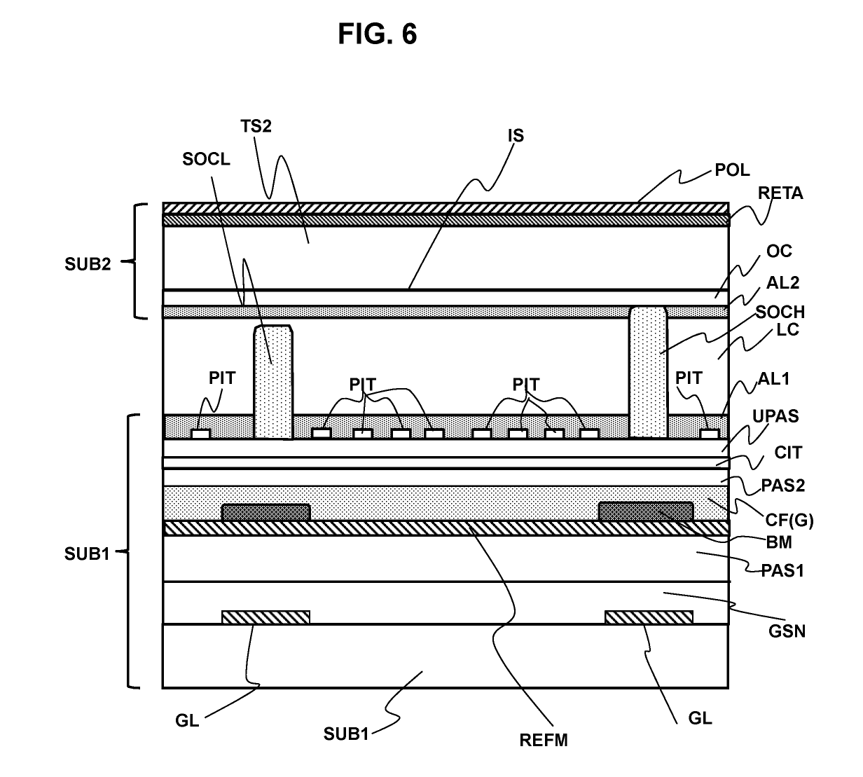

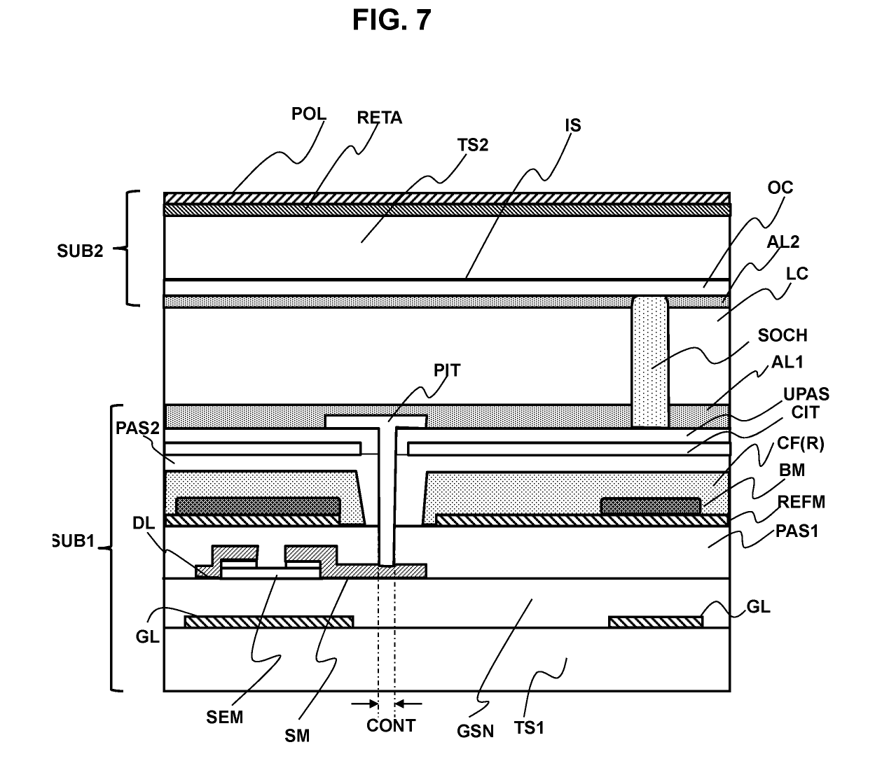

FIG. 4 is a cross-section of a sub-pixel of the blue sub-pixel region PX(B) including a TFT. This sectional view of the blue sub-pixel region PX (B) is basically the same as that of the red sub-pixel region PX (R) and the green sub-pixel region PX (G). FIG. 5 is a cross-section of three sub-pixels crossing in the horizontal direction. FIG. 6 is a cross-section of a sub-pixel of the green sub-pixel region PX(G) including the high gap spacer SOCH and the low gap spacer SOCL crossing in the vertical direction. This sectional view of the green sub-pixel region PX (G) is basically the same as that of the red sub-pixel region PX (R) and the blue sub-pixel region PX (B). FIG. 7 is a cross-section of a sub-pixel of the red sub-pixel region PX(R) including a TFT and a high gap spacer SOCH. This sectional view of the red sub-pixel region PX (R) is basically the same as that of the green sub-pixel region PX (G) and the blue sub-pixel region PX (B).

The liquid crystal display LCD includes a first substrate SUB1 and a second substrate SUB2, and the liquid crystal layer LC sandwiched and sealed therebetween. The first substrate SUB1 is a substrate assembly including a gate line GL, a gate insulator film GSN, a thin film transistor (TFT) including the semiconductor layer SEM, a data line DL and a source electrode SM, a first passivation film PAS1, a reflective electrode REFM, a black matrix BM, a color filter CF, a second passivation film PAS2, a common electrode CIT, an upper passive layer UPAS, a pixel electrode PIT and a first alignment layer AL1 being stacked on a first transparent substrate TS1. The first transparent substrate TS1 may be made of glass or organic material, such as polyimide. The liquid crystal display LCD according to the first embodiment may be designed for a curved or flexible display. The first transparent substrate TS1 made of organic material is preferable for a display device with a large curved ratio, because it is more flexible than the first transparent substrate TS1 made of glass.

The gate line GL is formed by a metallic material mainly containing aluminum (Al), molybdenum (Mo), titanium (Ti), or copper (Cu), a plurality of laminated layers thereof, an alloy in which tungsten (w), manganese (Mn), or titanium (Ti) is added to the metallic material, or a laminated metallic layer of a combination thereof. The thickness of the gate line GL is, for example, 100 to 300 nm. On the upper portion of the gate line GL, the gate insulator film GSN is formed. As the gate insulting film GSN, for example, a silicon nitride (SiN) formed with a plasma chemical vapor deposition method (CVD) can be used. The gate insulator film GSN may also be formed of silicon dioxide (SiO₂) or alumina (Al₂O₃).

The semiconductor layer SEM is processed into, for example, the shape of an island and is arranged above the gate line GL. As the semiconductor layer material of the semiconductor layer SEM, for example, a combination of a silicon nitride (SiN) and amorphous silicon (a-Si), a combination of silicon dioxide (SiO₂) and an oxide semiconductor or a low-temperature poly-silicon can be used. For example, as the oxide semiconductor, an oxide of indium-gallium-zinc or the like can be used.

At the end portions of the semiconductor layer SEM, the data line DL and the source electrode SM are formed. As the data line DL and the source electrode SM, a low-resistant metallic material can be used in the same material as the gate line GL. On the data line DL and the source electrode SM, the first passivation film PAS1 is formed. As the first passivation film PAS1, for example, a silicon nitride (SiN) or silicon dioxide (SiO₂) can be used. The first passivation film PAS1 has a thickness of, for example, 200 to 400 nm.

On the first passivation film PAS1, the reflective electrode REFM is formed to reflect an incident light from a side of the second substrate SUB2. A black matrix BM is formed on the reflective electrode REFM. The data line DL, the gate line GL and the thin film transistor TFT are covered by the black matrix BM having a light shielding effect entering from a side of the second substrate SUB2. When a semiconductor layer SEM is directly irradiated with external light, a resistance of the semiconductor layer SEM decreases and degrades a holding property of the liquid crystal display LCD, which results in a risk that a high quality image is not displayed. For this reason, in the first transparent substrate TS1, a black matrix BM is formed above the semiconductor layer SEM. The black matrix BM is also disposed at a boundary between the sub-pixels PX and overlaps with data lines DL and the gate lines GL. Therefore, color mixture caused by obliquely viewing the pieces of light of the pixels adjacent to each other is prevented to obtain a large advantageous effect that the image can be displayed without a blur and also to accentuate a boundary of each sub-pixel PX. The black matrix BM is made of black resin material having low reflective properties to prevent a color mixing. According to the first embodiment, color filters are included in the first substrate SUB1. The red sub-pixel region PX (R), the green sub-pixel region PX (G), the blue sub-pixel region PX (B) have red, green and blue colored color filters, respectively. The color filter is made of an organic material in which colored pigments are dispersed or is colored by dye.

As illustrated in FIGS. 4 to 7, there is overlap of electrode portions on the opposed faces of the common electrode CIT and the pixel electrode PIT with the upper passive layer UPAS interposed therebetween, and openings (slits) are formed in the pixel electrode PIT. There is no particular limitation to a shape of the slit. For example, the slit may be formed into a long and thin shape or a general opening such as a rectangular shape and an elliptical shape. A width of the slit may be larger or smaller than a distance between the slits adjacent to each other. The upper passive layer UPAS is preferably formed of an inorganic material, such as silicon dioxide (SiO₂) or alumina (Al₂O₃) between the pixel electrode PIT and the common electrode CIT. The upper passive layer UPAS can have a thickness of less than 1 um, for example, 200 to 400 nm.

As illustrated in FIGS. 6 and 7, the high gap spacer SOCH, and the low gap spacer SOCL which is lower than the high gap spacer SOCH are formed on the upper passive layer UPAS. The high gap spacer SOCH contacts the second substrate SUB2 without pressure imposed between the first substrate SUB1 and the second substrate SUB2 to maintain a gap between them. On the other hand, the low gap spacer SOCL does not contact the second substrate SUB2 without pressure imposed between the two substrates, but contacts the second substrate SUB2 with pressure imposed between the two substrates to resist the pressure by generating a contact area with the second substrate SUB2 in order to prevent a deterioration of the quality of an image.

The first alignment layer AL1 for aligning liquid crystal molecules of the liquid crystal layer LC is formed between the liquid crystal layer LC and the electrode layer of the common electrode CIT and the pixel electrode PIT. The pixel electrode PIT and the common electrode CIT constitute an electrode portion for forming the fringe electric field in the liquid crystal layer LC. As the configuration examples of these combinations, various combinations are possible.

On the other hand, the second substrate SUB2 is a substrate assembly only including an overcoat layer OC and a second alignment layer AL2 stacked on an inner surface IS of a second transparent substrate TS2. The inner surface IS faces the first substrate SUB1. No other layer is formed at least in the display region DISP other than the overcoat layer OC and the second alignment layer AL2.

In the same manner as the first alignment layer AL1, liquid crystal molecules in the liquid crystal layer LC are subjected to an alignment process of rubbing or photo-alignment in a predetermined alignment direction on the second alignment layer AL2 so as to have the predetermined initial alignment direction.

A phase difference film RETA and a polarization plate POL are adhered to the outside of the second transparent substrate TS2, but not to the outside of the first transparent substrate TS1, because the liquid crystal display according to the first embodiment is a reflective type. The phase difference film RETA shifts a phase of a quarter of a wave length of light-wave.

A method for driving the liquid crystal display LCD will briefly be described. The gate signal line GL is formed by the low-resistance metallic layer, and the scanning gate voltage is applied to the gate signal line GL from the scan line driving circuit GSC. The data line DL is formed by the low-resistance metallic layer, and the video data voltage is applied to the data line DL from the data line driving circuit DSC. When a gate-on voltage is applied to the gate line GL, the semiconductor layer SEM of the thin film transistor TFT becomes a low-resistant state, and the data voltage applied to the data line DL is transmitted to the pixel electrode PIT through the source electrode SM that is formed by the low-resistance metallic layer and electrically connected to the pixel electrode PIT.

The common voltage is applied to the common electrode CIT from a common-electrode driving circuit. The common electrode CIT overlaps the pixel electrode PIT with the upper insulating film UPAS being interposed therebetween. The fringe electric field is generated in the vicinity of the openings in the pixel electrode PIT in the liquid crystal layer LC by the potential difference, so that an alignment state of the liquid crystal molecules is controlled so as to rotate the liquid crystal molecules LCM in the substrate in-plane direction.

Hence, external light, such as sunlight or a desktop light which passes through the polarization plate POL is polarized. The polarized light is changed in phase by a quarter of a wave length due to the phase difference film RETA and thereafter passed through the liquid crystal layer LC, and the light passes through the pixel electrode PIT, the common electrode CIT and the color filters CF. Thereafter the light is reflected on the reflective electrode REFM and then the reflected light passes through the same route as the incident light.

When the TFT is turned off, the fringe electric field is not generated between the pixel electrode PIT and the common electrode CIT. The light passing through the liquid crystal layer LC is not affected by the liquid crystal layer LC, and thus the reflected light which passes through the phase difference film RETA again is blocked by the polarization plate POL. Therefore the sub-pixel PX displays black. This operation is so-called a normally black mode.

When the TFT is turned on, the fringe electric field is generated between the pixel electrode PIT and the common electrode CIT. The light passing through the liquid crystal layer LC is formed into oval polarized light by the optical birefringence effect of the liquid crystal layer LC. The liquid crystal display LCD is optically designed to change a phase of light passing through one direction of the liquid crystal layer LC by a quarter of a wave length in maximum. Therefore the incident light from outside passes through the liquid crystal layer LC and a color filter, such as a blue color filter CF(B), for example, is reflected on the reflective electrode REFM, passes the color filter and the liquid crystal layer LC and then can travel outside the liquid crystal display LCD as linear polarized light by not being blocked totally by the polarization plate POL. Thus, the sub-pixel PX displays a color, a blue, for example. The liquid crystal display LCD is designed to change its transmittance according to its drive voltage, with the result that it is possible to produce a white display with a gray-scale.

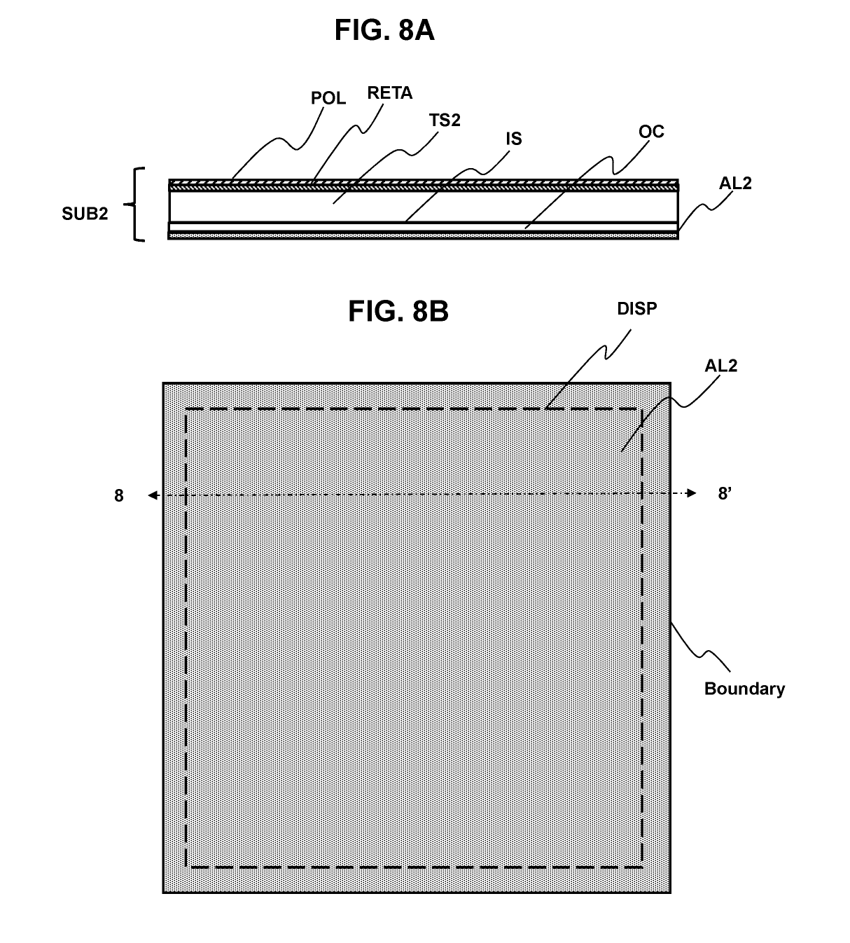

According to the first embodiment, as illustrated in FIGS. 4 to 7, the color filters CF, the black matrix BM and even the spacer SOCH and SOCL are formed in the first substrate SUB1, but are not formed at least in the display region DISP of the second substrate SUB2. In this regard, FIG. 8A is a schematic diagram of a cross-section of the second substrate SUB2 taken along a line 8-8′ in FIG. 8B, and FIG. 8B is a bottom plan view of the second substrate SUB2 of the liquid crystal display LCD according to the first embodiment. According to FIG. 8A and FIG. 8B, the overcoat layer OC and the second alignment layer AL2 are stacked on a whole area of an inner surface IS of the second transparent substrate TS2. The inner surface IS of the second transparent substrate TS2 faces the first substrate SUB1. In a display region DISP of the second substrate SUB2, because color filters CF, a black matrix BM, and spacers SOCH and SOCL are not formed therein, and because the overcoat layer OC and the second alignment layer AL2 are formed on the whole area of the inner surface IS of the second transparent substrate TS2, there is no area defined by a boundary of each layer formed on the second substrate SUB2 that is smaller than an area of one sub-pixel PX in plan view. The boundary of each layer means a boundary between a presence and an absence of a specific layer. Thus the boundary of the overcoat layer OC and the second alignment layer AL2 defines end lines of the second transparent substrate TS2, which is present outside of the display region of the second substrate SUB2.

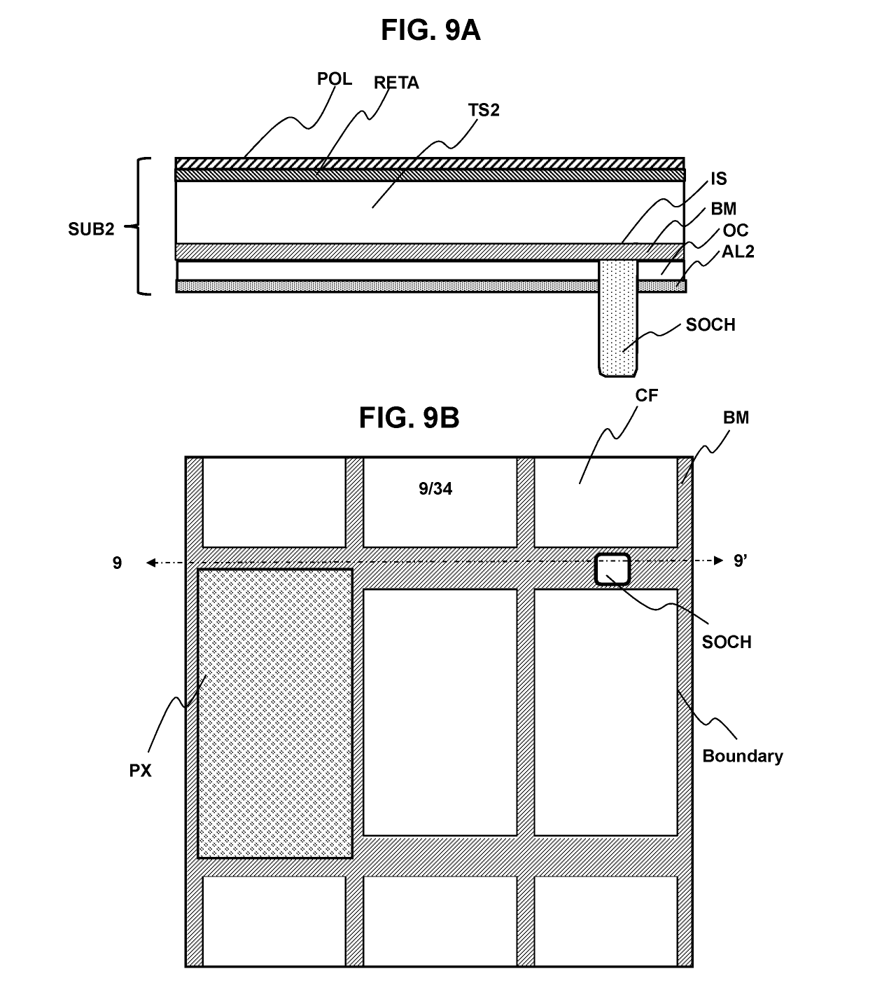

FIG. 9A is a schematic diagram of a partial cross-section of a second substrate taken along a line 9-9′ in FIG. 9B, and FIG. 9B is a partial bottom plan view of a second substrate of a liquid crystal display device as a comparative example. The overcoat layer OC and the second alignment layer AL2 are omitted for simplicity. In this comparative example, there are color filters, each color filter CF being surrounded by a black matrix BM, and a spacer SOCH formed in the display region DISP of the second substrate SUB2. A boundary between the color filter CF and the black matrix BM defines an area of the color filter CF, which is smaller than an area of the sub-pixel PX in plan view shown in FIG. 9B for reference. In this case, an alignment between the first substrate SUB1 and the second substrate SUB2 should be precise and a layer pattern like the spacer SOCH should be fitted to a position in a certain range, which is smaller than a sub-pixel PX.

In contrast, because the second substrate SUB2 of the liquid crystal display LCD according to the first embodiment does not have any area defined by a boundary of each layer that is smaller than an area of a sub-pixel PX, there are advantages in comparison to the comparative example of the liquid crystal display LCD as shown in FIGS. 9A and 9B. First, a quality of an image is not deteriorated, even when the first substrate SUB1 and the second substrate SUB2 are roughly aligned. Second, even when the liquid crystal display LCD is curved, and one of the first substrate SUB1 and the second substrate SUB2 is expanded and the other is shrunk, it is not necessary to be concerned about achieving a precise alignment between the first substrate SUB1 and the second substrate SUB2, because a pattern size of all layers formed in the display region DISP of the second substrate SUB2 is larger than a size of a sub-pixel PX. Therefore, the liquid crystal display according to the first embodiment is preferable for a curved display or a flexible display, and a good color image can be realized, even when one of the first substrate SUB1 and the second substrate SUB2 is expanded and the other is shrunk.

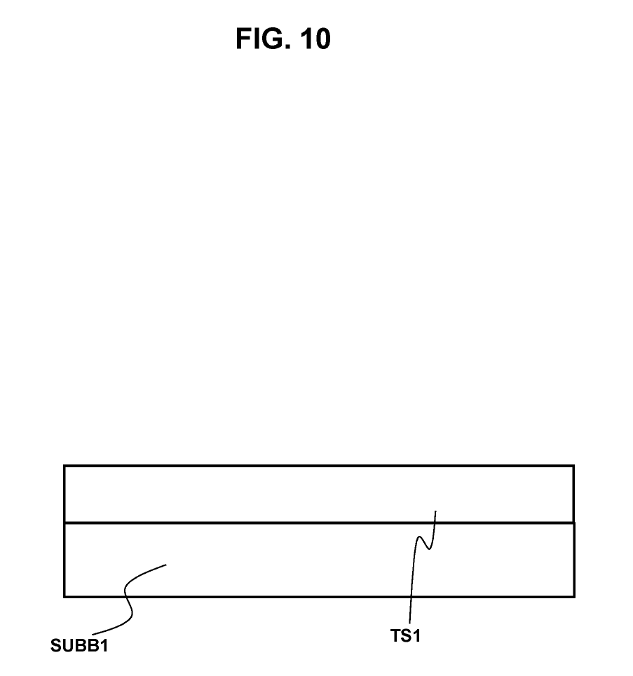

FIGS. 10 to 23 illustrate a process of manufacturing the liquid crystal display LCD according to the first embodiment. These figures correspond to FIG. 7.

FIG. 10 is a schematic diagram of a cross-section after a first step of a manufacturing process. A heat-resistant polyimide is spread with even thickness on a first base substrate SUBB1 made of glass, and is dried by heating. The heat-resistant polyimide is changed into the first substrate SUB1, which is stable even under an atmosphere at a temperature of more than 400 degrees Celsius. A semiconductor material, such as poly-silicon, oxide semiconductor, or amorphous silicon, a metallic material and/or an insulating layer can be formed by a chemical vapor deposition (CVD) on the heat-resistant polyimide layer. At this point, as the first base substrate SUBB1 can have a function of a mold, when a curved display is manufactured, the first base substrate SUBB1 is shaped in a curve. Instead of this combination of the first base substrate SUBB1 and the heat-resistant polyimide, a normal glass substrate may be used in the same manner as a conventional liquid crystal display LCD.

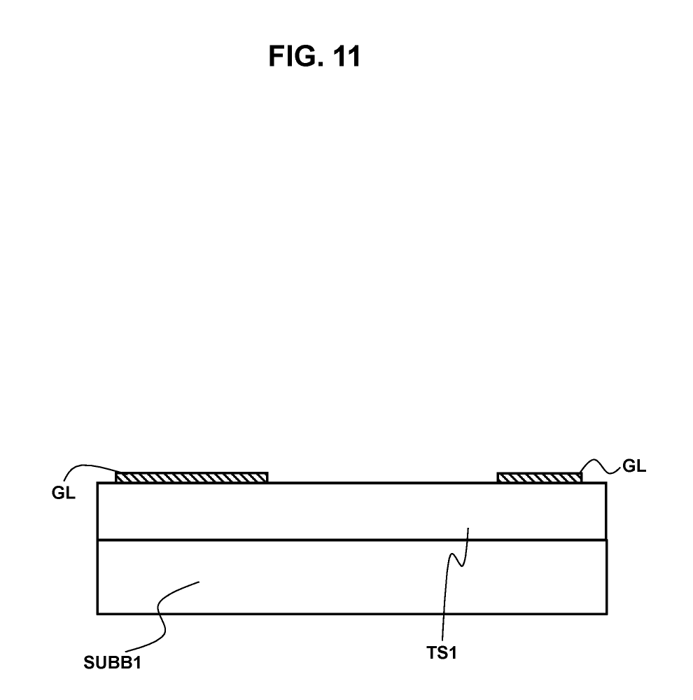

FIG. 11 is a schematic diagram of a cross-section after a second step of a manufacturing process. A metallic material constituting the gate line GL is deposited on the first transparent substrate TS1 by sputtering, and patterned. For example, the metallic material is a laminated film including copper (Cu) having thickness of 100 nm to 300 nm and molybdenum (Mo) deposited thereon. Alternatively, a laminated film of molybdenum (Mo) and aluminum (Al), a laminated film of titanium (Ti) and aluminum (Al), or a MoW alloy of molybdenum (Mo) and tungsten (W) may be used as the metallic material.

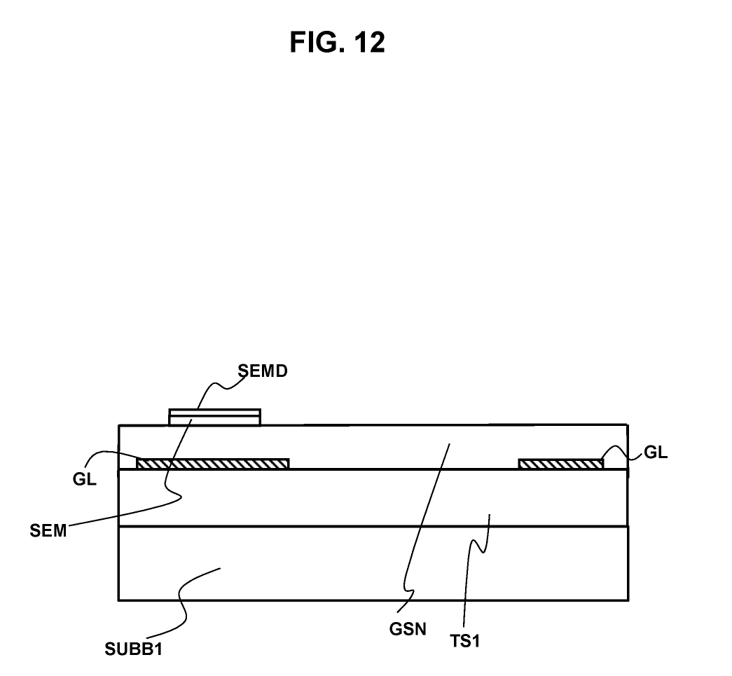

FIG. 12 is a schematic diagram of a cross-section after a third step of a manufacturing process. As illustrated in FIG. 12, by chemical vapor deposition (CVD), the silicon-nitride gate insulating film GSN is deposited so as to cover the gate line GL, and the amorphous-silicon semiconductor layer SEM and a contact semiconductor layer SEMD made of a silicon with a high density of phosphorous (P) are laminated on the gate insulating film GSN.

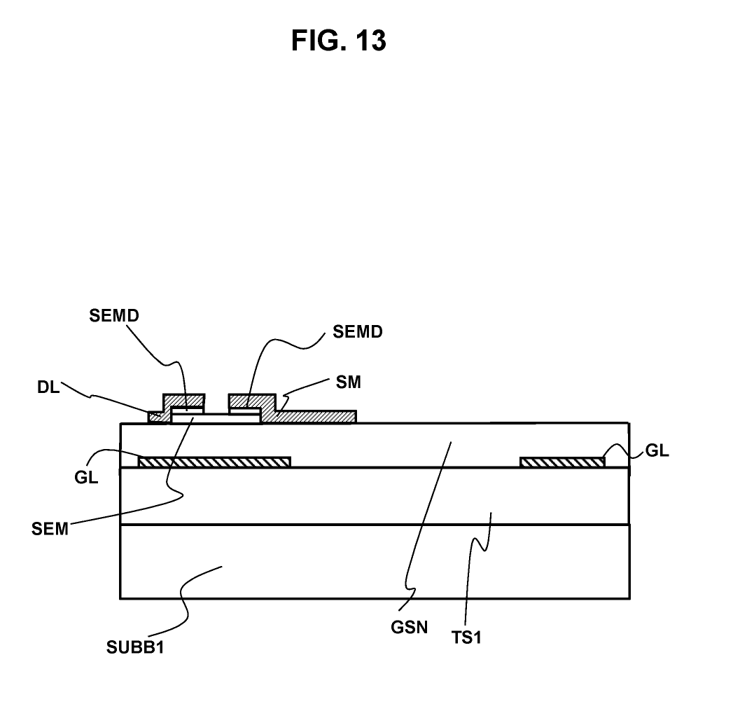

FIG. 13 is a schematic diagram of a cross-section after a fourth step of a manufacturing process. The laminated film of molybdenum (Mo) and copper (Cu) is deposited on the semiconductor layer SEM by sputtering. The data line DL and the source electrode SM are simultaneously formed. The material of the gate line GL can be used for the data line DL and the source electrode SM. The contact semiconductor layer SEMD over the semiconductor layer SEM is removed in a region of the thin film transistor TFT between the data line DL and the source electrode SM.

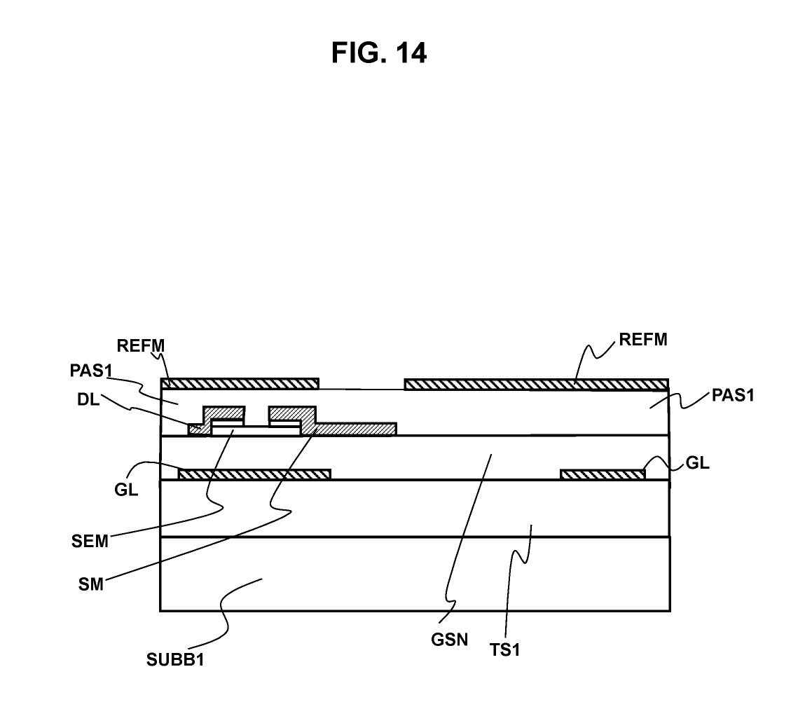

FIG. 14 is a schematic diagram of a cross-section after a fifth step of a manufacturing process. A first protective insulating film PAS1 made of silicon-nitride (SiN) is laminated by chemical vapor deposition (CVD) so as to cover the data line DL, and the source electrode SM. A metallic material such as aluminum (Al) or silver (Ag) is deposited on the first substrate SUB1 by sputtering, and patterned into the reflective substrate REFM.

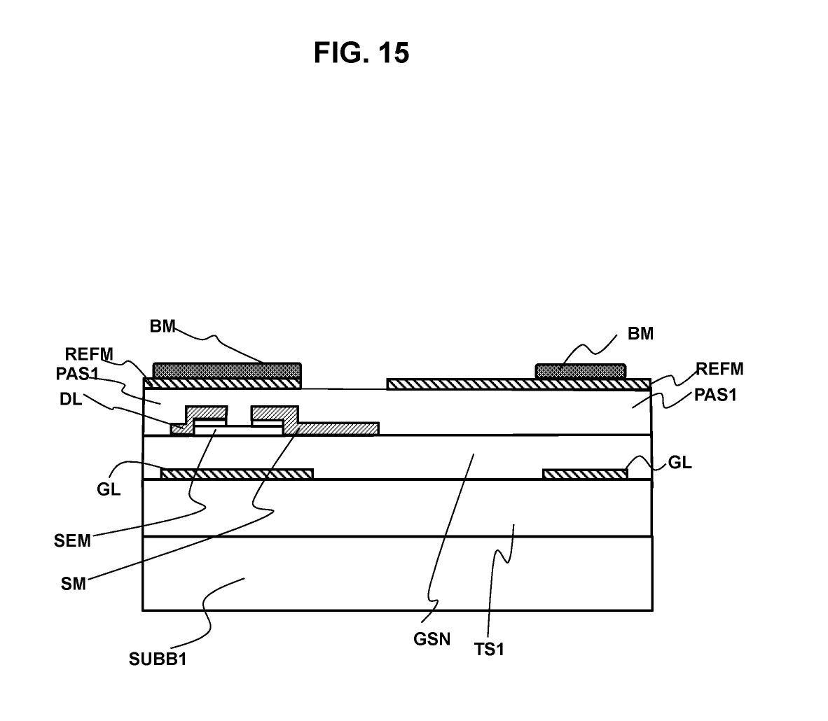

FIG. 15 is a schematic diagram of a cross-section after a sixth step of a manufacturing process. A photo-sensitive resin including a carbon is spread, and is patterned into a black matrix BM by a photo-process.

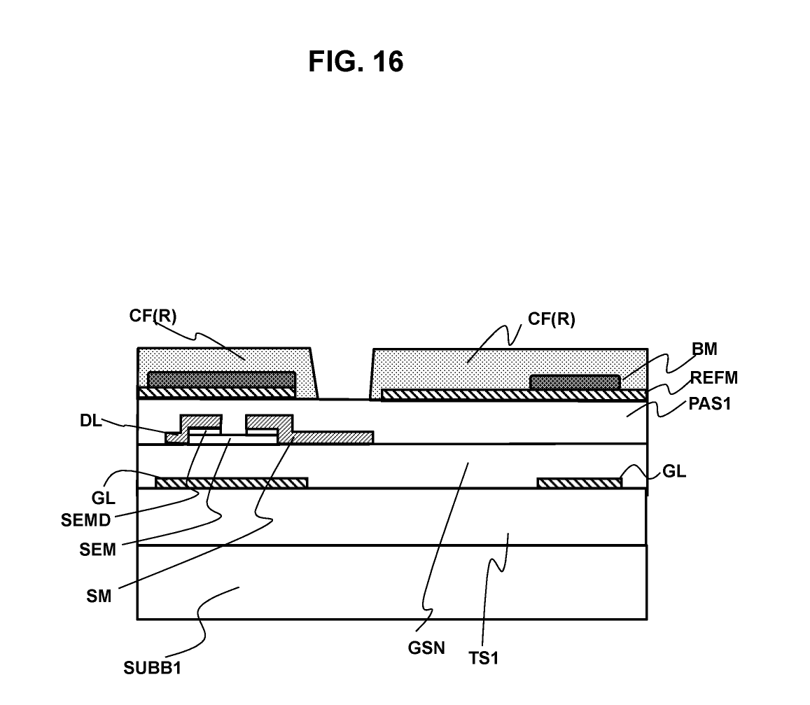

FIG. 16 is a schematic diagram of a cross-section after a seventh step of a manufacturing process. A photo-sensitive resin including colored pigment is spread, and is patterned by a photo-process into the color filter, such as the red color filter CF(R).

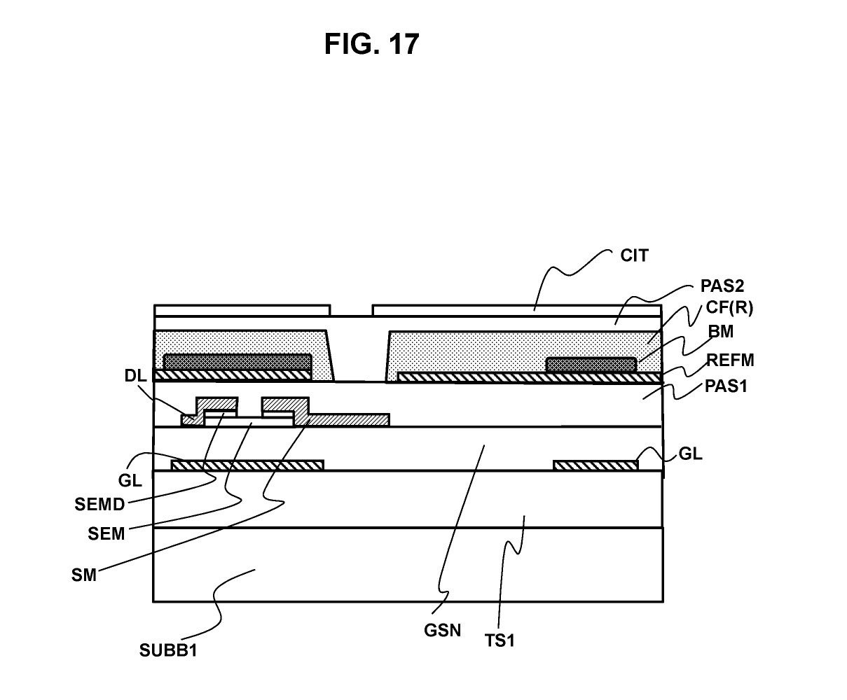

FIG. 17 is a schematic diagram of a cross-section after an eighth step of a manufacturing process. A second protective insulating film PAS2 is laminated by a chemical vapor deposition (CVD) so as to prevent the color pigment from dissolving into the liquid crystal layer LC. A common electrode CIT is patterned by a photo-etching process after a transparent conductive layer made of indium tin oxide (ITO) is deposited on the second protective insulating film PAS2.

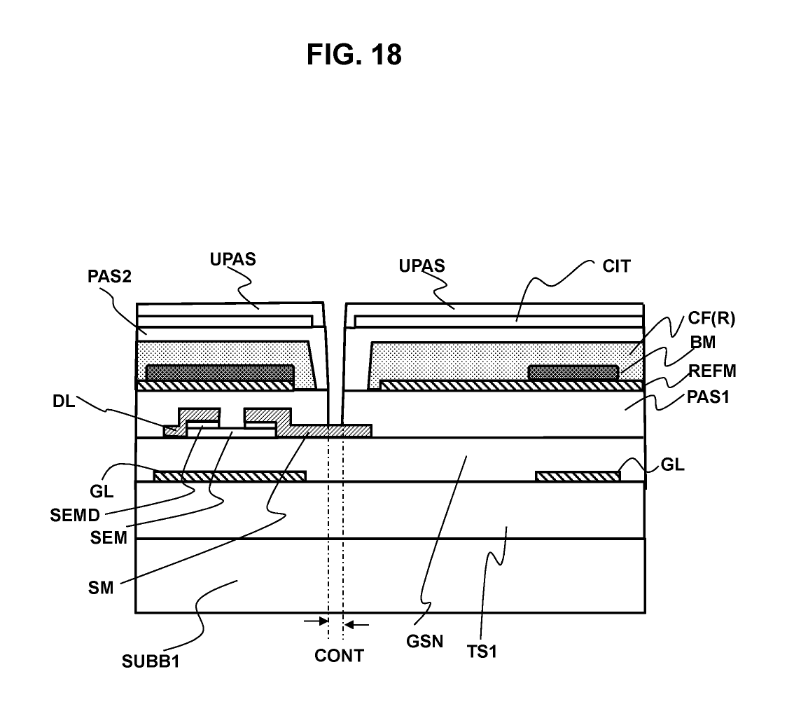

FIG. 18 is a schematic diagram of a cross-section after a ninth step of a manufacturing process. An upper protective insulating film UPAS made of the same inorganic material as the first passivation film PAS1 and the second passivation film PAS2 is laminated by a chemical vapor deposition (CVD). A through-hole portion CONT is formed over the source electrode SM through the first protective insulating film PAS1, the second protective insulating film PAS2 and the upper protective insulating film UPAS.

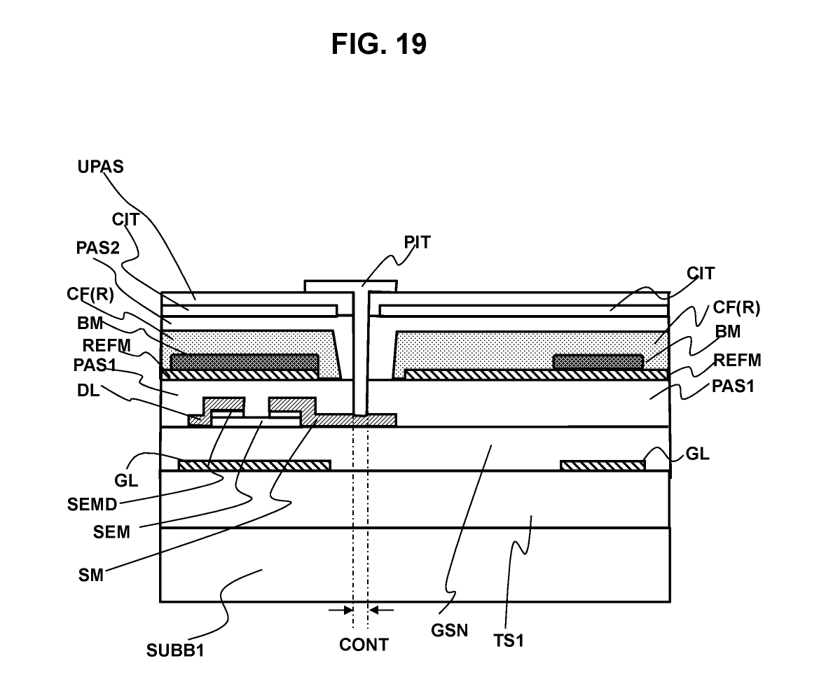

FIG. 19 is a schematic diagram of a cross-section after a tenth step of a manufacturing process. The pixel electrode PIT is formed by a photo-etching process after a transparent conductive layer made of indium tin oxide (ITO) is deposited on the upper protective insulating film UPAS and inside the through-hole portion CONT to electrically connect with the pixel electrode PIT and the source electrode SM.

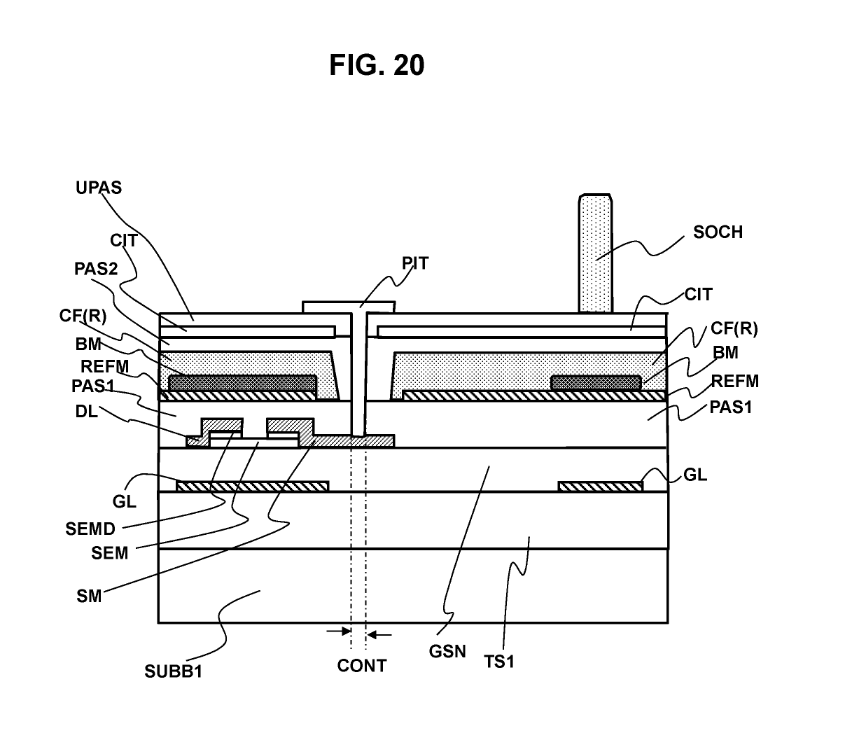

FIG. 20 is a schematic diagram of a cross-section after an eleventh step of a manufacturing process. A photo-sensitive resin is spread, and is patterned into the high gap spacer SOCH and the low gap spacer SOCL by photo-etching.

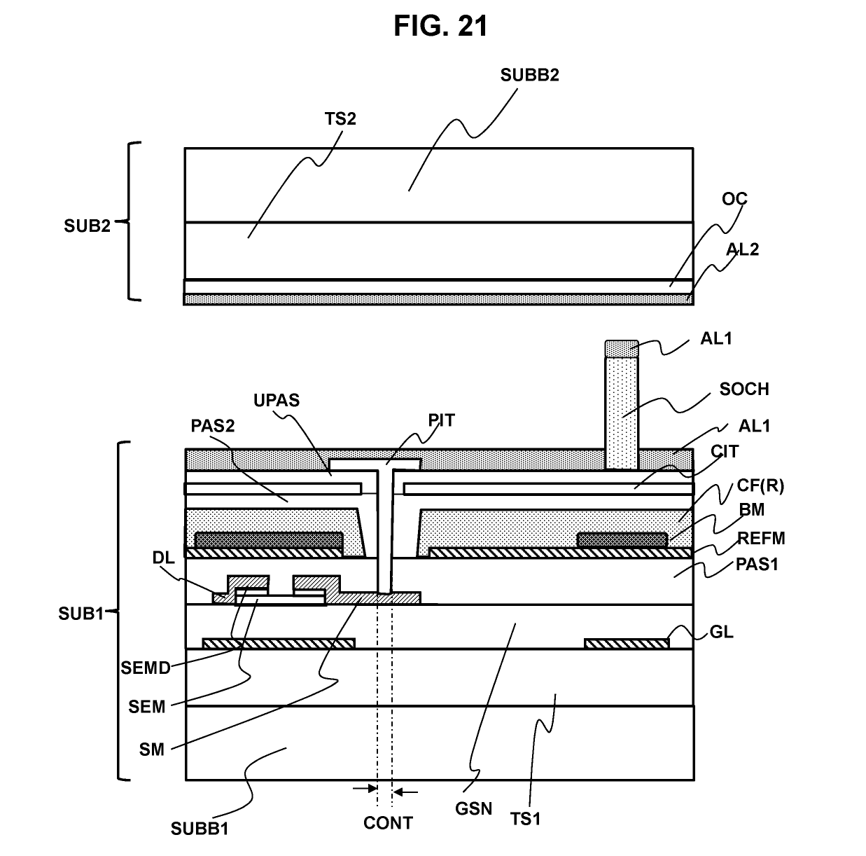

FIG. 21 is a schematic diagram of a cross-section after a twelfth step of a manufacturing process. In the same manner as FIG. 10, a heat-resistant polyimide is spread with even thickness on a first base substrate SUBB2 made of glass, and is dried by heating. The heat-resistant polyimide is changed into the second transparent substrate TS2. An overcoat layer OC is formed on the second transparent substrate TS2 by spreading of an organic material. A first alignment layer AL1 and a second alignment layer AL2 are formed in the first substrate SUB1 and the second substrate SUB2, respectively. These layers are subjected to a photo alignment process. A rubbing process may be applied instead of the photo alignment process.

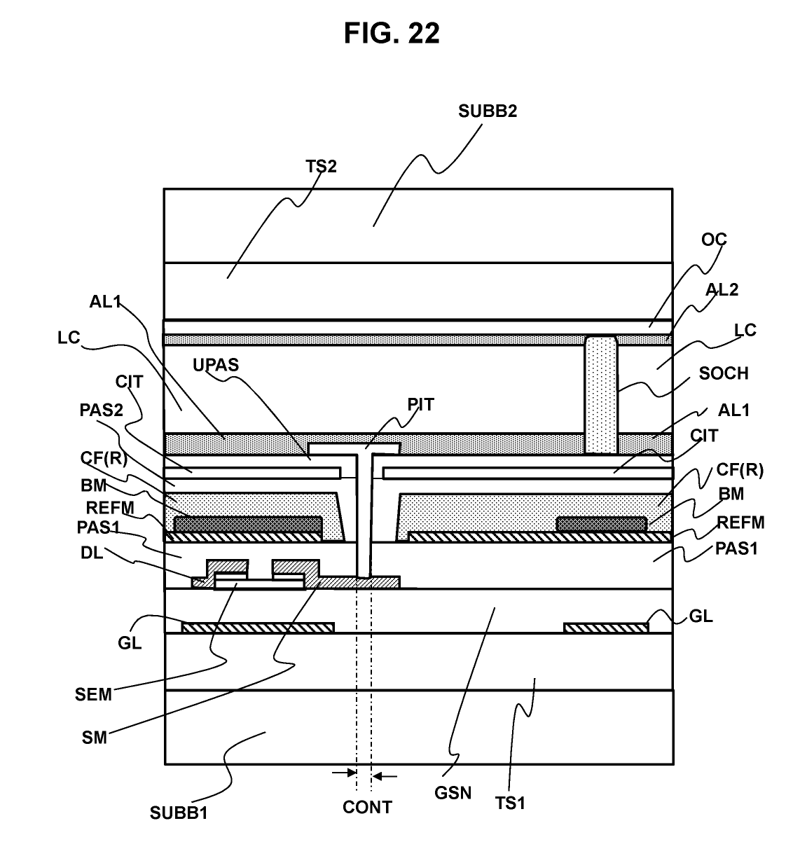

FIG. 22 is a schematic diagram of a cross-section after a thirteenth step of a manufacturing process. A seal resin with a certain width is formed outside the display region DISP as an adhesive. After droplets of liquid crystal molecules are dropped on the second substrate SUB2, the first substrate SUB1 and the second substrate SUB2 are combined with the first alignment layer AL1 and the second alignment layer AL2 facing each other. The liquid crystal layer LC is sealed by hardening the seal resin with irradiating an ultraviolet light to the seal resin.

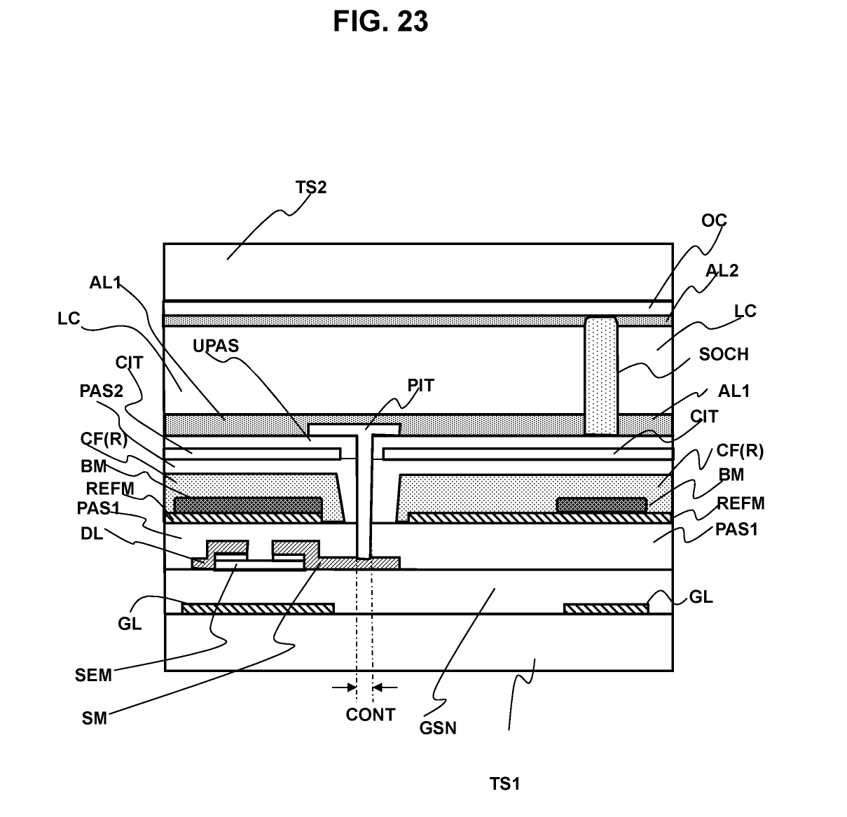

FIG. 23 is a schematic diagram of a cross-section after a fourteenth step of a manufacturing process. The first base substrate SUBB1 and the second base substrate SUBB2 are removed by irradiating a laser light on their surfaces or removed mechanically. Thereafter, a phase difference film RETA and a polarization plate POL are adhered to the outside surface of the second transparent substrate TS2, which complete the liquid crystal display LCD illustrated in FIG. 7.

### Second Embodiment

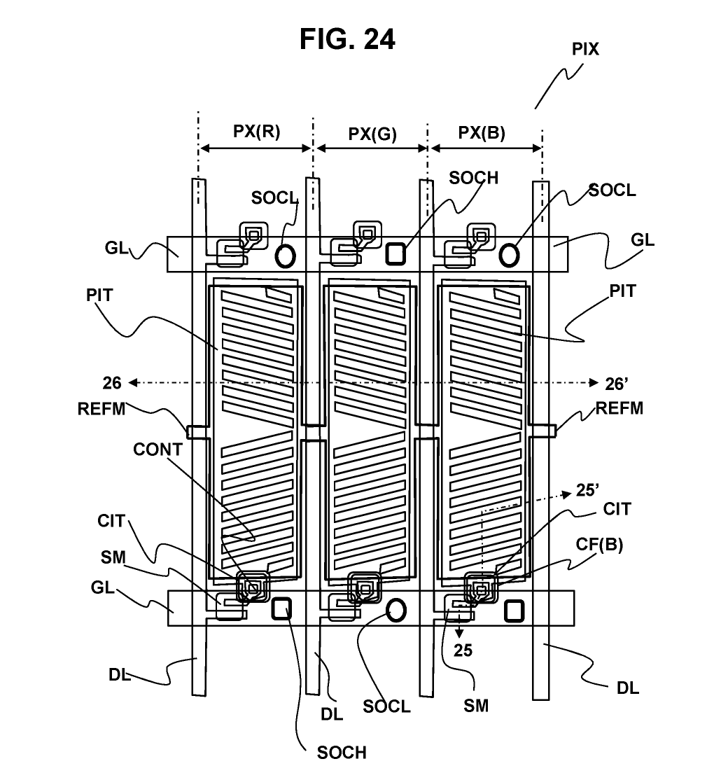

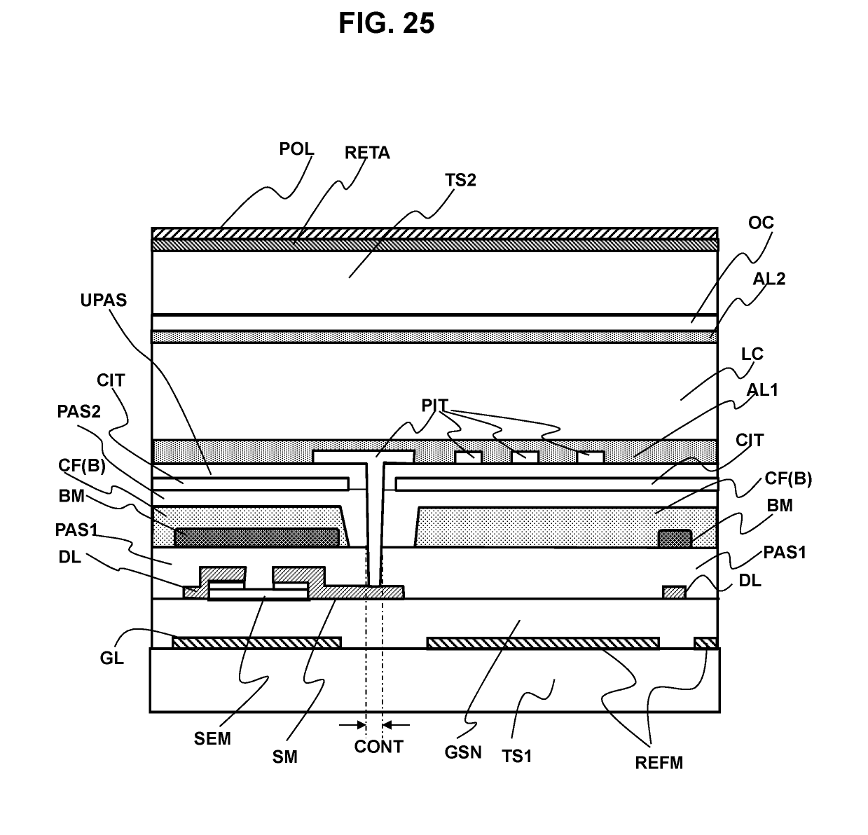

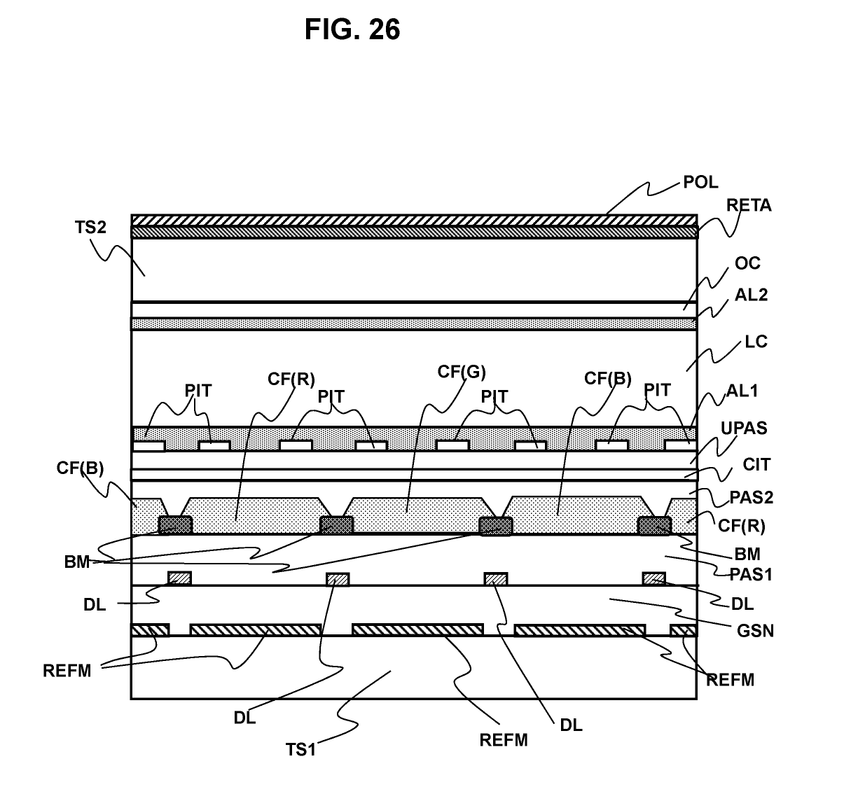

A second exemplary embodiment of the present disclosure will be described below with reference to the drawings. For convenience, the components having the same function as that of the first exemplary embodiment are designated by the same reference marks, and the description is omitted. An entire configuration and a circuit diagram of a drive circuit of a liquid crystal display device LCD according to a second exemplary embodiment is identical to that in FIGS. 1 and 2, respectively. FIG. 24 is a plan view illustrating a pixel PIX including three sub-pixels PX in the liquid crystal display LCD according to the second embodiment. FIG. 25 is a schematic diagram of a cross-section taken along line 25-25′ in FIG. 24. FIG. 26 is a schematic diagram of a cross-section taken along line 26-26′ in FIG. 24.

According to the second embodiment, a reflective electrode REFM is formed of the same metallic material and in the same layer as the gate line GL. The reflective electrode REFM has a pattern extending in a horizontal direction in parallel with the gate line GL. The metallic material of both the reflective electrode REFM and the gate line GL is preferably aluminum (Al) in view of their reflective ratio, expense and electric conductivity.

In a sub-pixel PX, the pattern of the reflective electrode REFM has a shape corresponding to the sub-pixel PX. The reflective electrodes REFM formed in the two adjacent sub-pixels arrayed in the horizontal direction are connected with each other by a bridge electrode which has a narrower width in the vertical direction than the reflective electrodes REFM inside a sub-pixel PX. The bridge electrode overlaps a data line DL. The bridge electrode of the reflective electrodes REFM may have the same width in the vertical direction as the reflective electrodes REFM inside a sub-pixel PX. According to the second embodiment, because the reflective electrode REFM and the gate line GL can be manufactured in the same step, time and expense can be saved in the manufacturing of the liquid crystal display LCD.

### Third Embodiment

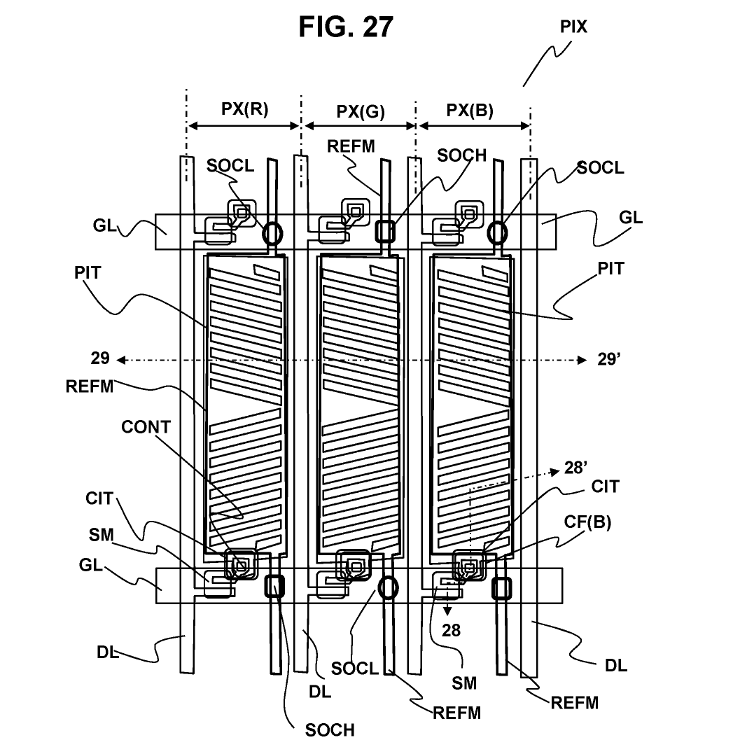

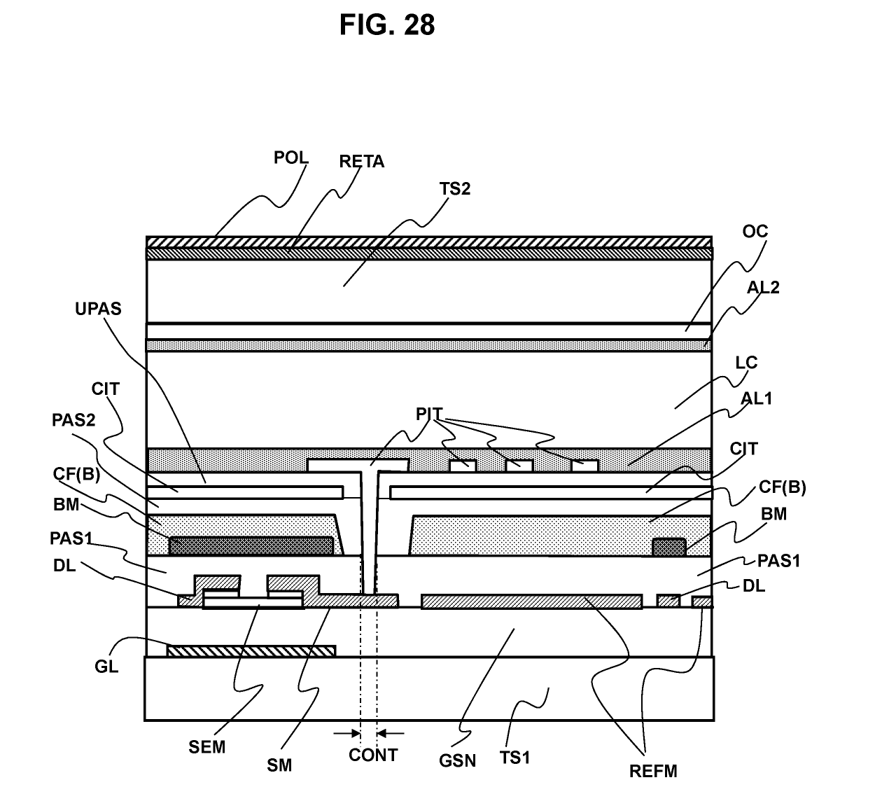

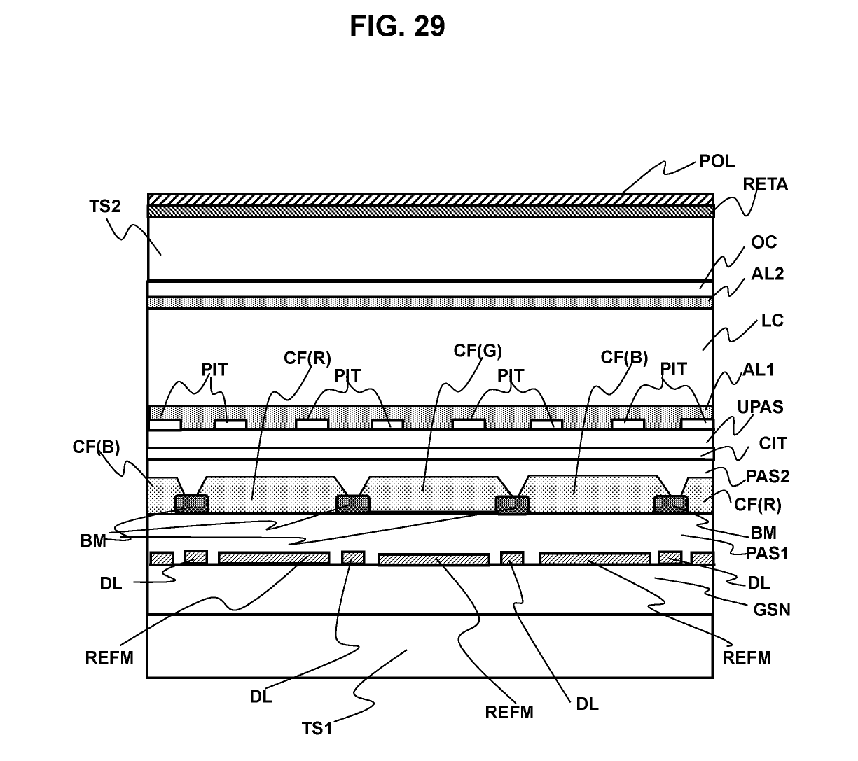

A third exemplary embodiment of the present disclosure will be described below with reference to the drawings. For convenience, the components having the same function as that of the first exemplary embodiment are designated by the same reference marks, and the description is omitted. An entire configuration and a circuit diagram of a drive circuit of a liquid crystal display device LCD according to the third exemplary embodiment is identical to that in FIGS. 1 and 2, respectively. FIG. 27 is a plan view illustrating a pixel PIX including three sub-pixels PX in the liquid crystal display device. FIG. 28 is a schematic diagram of a cross-section taken along line 28-28′ in FIG. 27. FIG. 29 is a schematic diagram of a cross-section taken along line 29-29′ in FIG. 27.

According to the third embodiment, a reflective electrode REFM is formed of the same metallic material and in the same layer as the data line DL. The reflective electrode REFM has a pattern extending in the vertical direction in parallel with the data line DL. The metallic material of both the reflective electrode REFM and the data line DL is preferably aluminum (Al) in view of their reflective ratio, expense and electric conductivity. In a sub-pixel PX, the pattern of the reflective electrode REFM has a shape corresponding to the sub-pixel PX. The reflective electrodes REFM in the two adjacent sub-pixels arrayed in the vertical direction are connected with each other by a bridge electrode which has a narrower width in the horizontal direction than the reflective electrodes REFM inside a sub-pixel PX. The bridge electrode overlaps a gate line GL. According to the third embodiment, because the reflective electrode REFM and the gate line GL can be manufactured in the same step, time and expense can be saved in the manufacturing of the liquid crystal display LCD.

### Fourth Embodiment

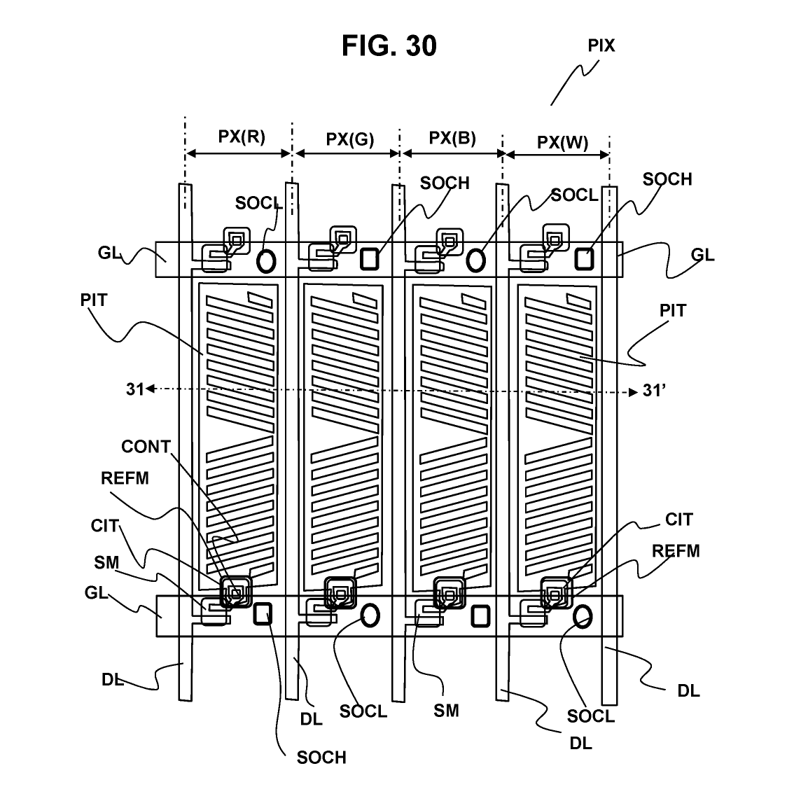

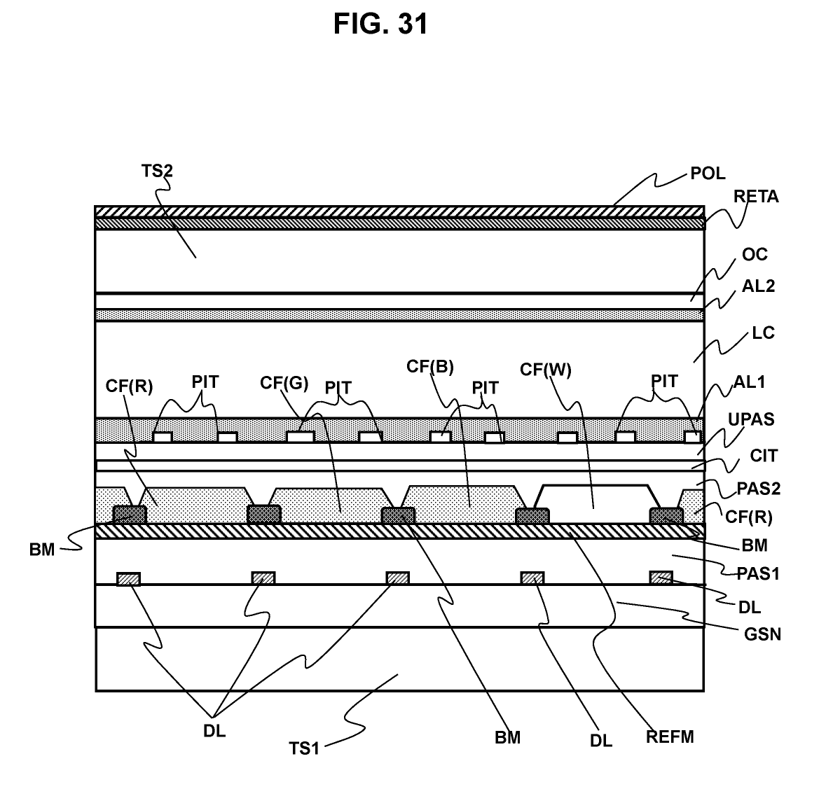

A fourth exemplary embodiment of the present disclosure will be described below with reference to the drawings. For convenience, the components having the same function as that of the first exemplary embodiment are designated by the same reference marks, and the description is omitted. An entire configuration and a circuit diagram of a drive circuit of a liquid crystal display device LCD according to the fourth exemplary embodiment is identical to that in FIGS. 1 and 2, respectively. FIG. 30 is a plan view illustrating a pixel including four sub-pixels in the liquid crystal display device. FIG. 31 is a schematic diagram of a cross-section taken along line 31-31′ in FIG. 30.

The liquid crystal display LCD according to the fourth embodiment includes one pixel PIX comprising four sub-pixels PX, including a red sub-pixel PX(R), a green sub-pixel PX(G), a blue sub-pixel PX(B) and a white sub-pixel PX(W). A white color filter CF(W) of the white sub-pixel PX(W) is formed by a transparent resin without a color pigment, which results in a higher transmittance than a colored color filter, such as the red color filter CF(R) for example. A white image displayed in the liquid crystal display LCD according to the fourth embodiment is 1.5 times higher than that in a conventional liquid crystal display.

### Fifth Embodiment

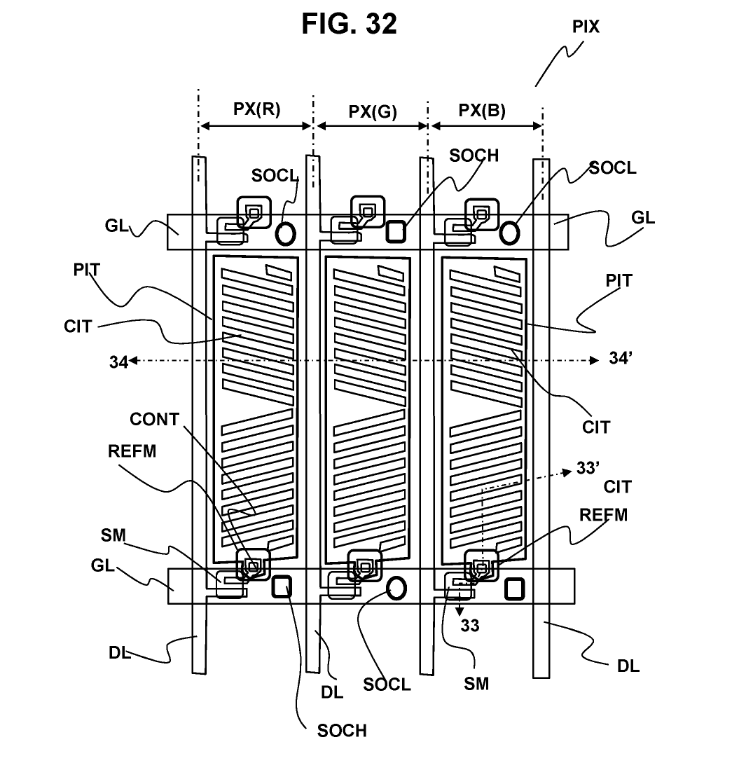

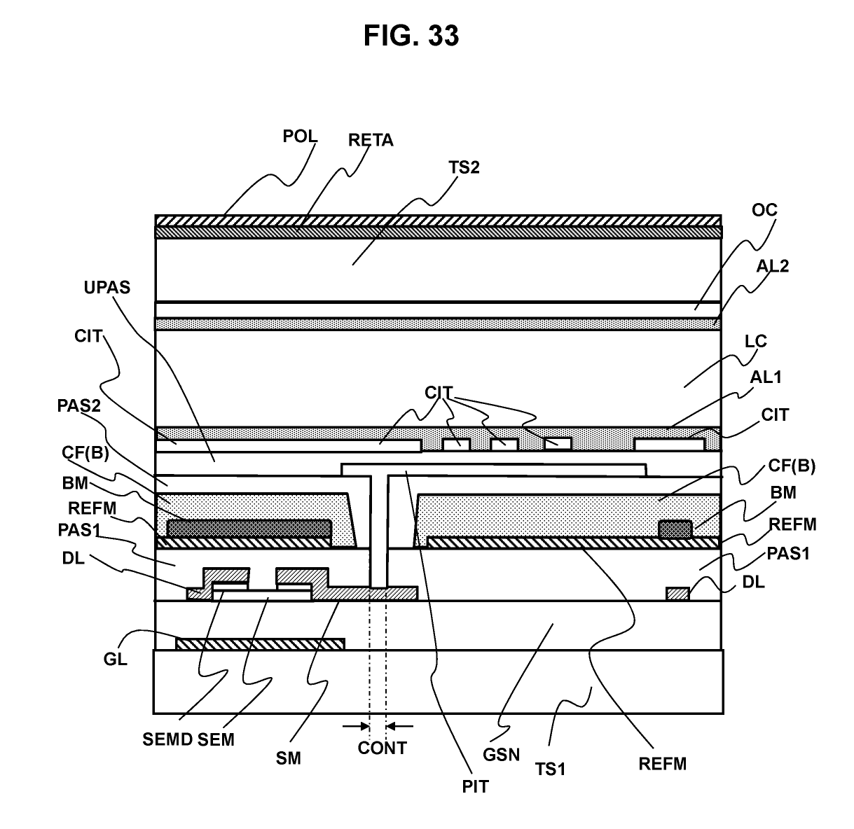

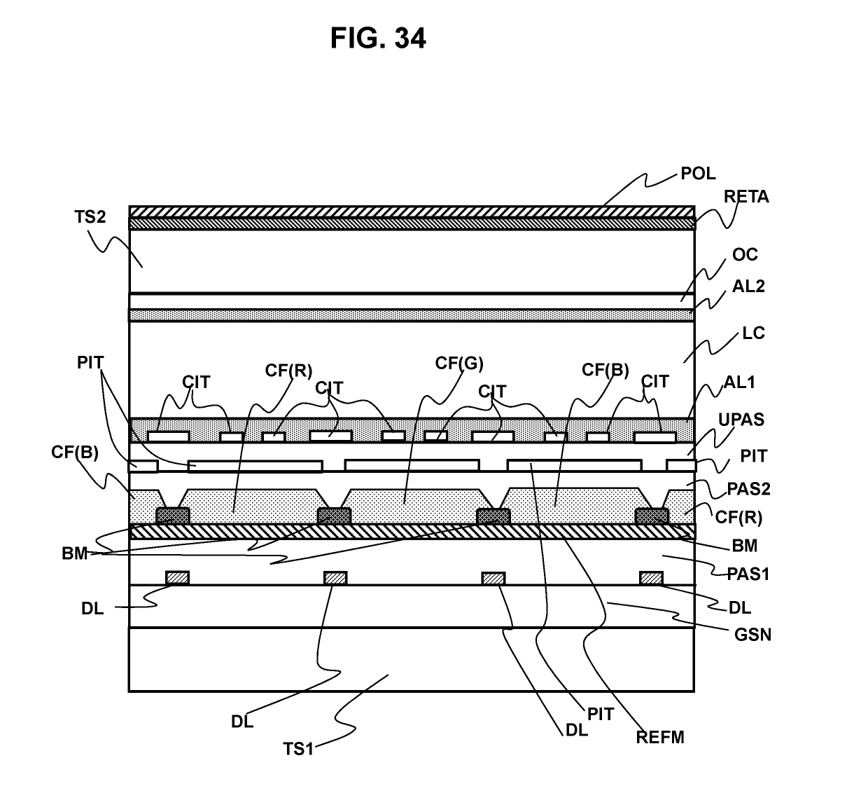

A fifth exemplary embodiment of the present disclosure will be described below with reference to the drawings. For convenience, the components having the same function as that of the first exemplary embodiment are designated by the same reference marks, and the description is omitted. An entire configuration and a circuit diagram of a drive circuit of a liquid crystal display device LCD according to the fifth exemplary embodiment is identical to that in FIGS. 1 and 2, respectively. FIG. 32 is a plan view illustrating a pixel PIX including three sub-pixels PX in the liquid crystal display device. FIG. 33 is a schematic diagram of a cross-section taken along line 33-33′ in FIG. 32. FIG. 34 is a schematic diagram of a cross-section taken along line 34-34′ in FIG. 32.

According to the fifth embodiment, a common electrode CIT is formed closer to a liquid crystal layer LC than a pixel electrode PIT. The common electrode CIT is formed into a flat shape in the whole of the display region DISP. The common electrode CIT covers the data line DL and the gate line GL to act as a shield electrode. Therefore, for example, an electric field noise generated from the data line DL and the gate line GL can be prevented from entering the liquid crystal layer LC. Inside each sub-pixel PX region, openings (slits) are formed in the common electrode CIT. There is no particular limitation to a shape of the slits. For example, the slits may be formed into a long and thin shape or a general opening such as a rectangular shape and an elliptical shape. A width of the slit may be larger or smaller than a distance between the slits adjacent to each other. On the other hand, no opening is formed in a region where the contact hole CONT and a part (source electrode) of thin film transistor TFT are formed in plan view and the common electrode CIT overlaps a whole area of a TFT. In contrast, no opening (slit) is formed in the pixel electrode PIT. The pixel electrode has a rectangular shape corresponding to a sub-pixel PX.

Although exemplary embodiments of the present disclosure are described above, the present disclosure is not limited to the exemplary embodiments. It is noted that an exemplary embodiment properly modified with respect to the above-described exemplary embodiments by those skilled in the art without departing from the scope of the present disclosure is included in the present disclosure.

What is claimed is:

1. A liquid crystal display device comprising:
a first substrate;
a second substrate facing the first substrate;
a liquid crystal layer sandwiched between the first substrate and the second substrate; and
a plurality of spacers maintaining a gap between the first substrate and the second substrate,
wherein a display region of the first substrate includes:
a first alignment layer;
a plurality of data lines extending in a first direction;
a plurality of gate lines extending in a second direction which is different from the first direction; and
a plurality of pixels arranged in a matrix, each of the plurality of pixels including a plurality of sub-pixels, and each of the plurality of sub-pixels including:
a thin film transistor;
a pixel electrode connected to the thin film transistor;
a common electrode that is opposed to the pixel electrode;
a reflective electrode;
a light-shielding layer; and
a color filter,
wherein a display region of the second substrate includes a second alignment layer, and
wherein the plurality of spacers is integrally formed in the first substrate.

2. The liquid crystal display device of claim 1,
wherein the second substrate includes a second transparent substrate,
wherein only an overcoat layer and the second alignment layer are formed in the display region of a first surface of the second transparent substrate, and
wherein the first surface of the second transparent substrate faces the first substrate.

3. The liquid crystal display device of claim 1,
wherein the plurality of spacers includes a first spacer and a second spacer, the first spacer contacting the second substrate and the second spacer not contacting the second substrate.

4. The liquid crystal display device of claim 1,
wherein the light-shielding layer is a black matrix.

5. The liquid crystal display device of claim 1,
wherein the reflective electrode is disposed in the same layer as the gate lines.

6. The liquid crystal display device of claim 1,
wherein the reflective electrode is disposed in the same layer as the data lines.

7. The liquid crystal display device of claim 1,
wherein the plurality of sub-pixels includes a red sub-pixel, a green sub-pixel, a blue sub-pixel and a white sub-pixel.

8. The liquid crystal display device of claim 7,
wherein in each of the plurality of sub-pixels, the common electrode and the pixel electrode are formed closer to the liquid crystal layer than the color filter.

9. The liquid crystal display device of claim 1,
wherein the liquid crystal display device is a curved display.

10. A display device comprising:
a first substrate;
a second substrate facing the first substrate; and
a plurality of spacers maintaining a gap between the first substrate and the second substrate,
wherein a display region of the first substrate includes:
a plurality of data lines extending in a first direction;
a plurality of gate lines extending in a second direction which is different from the first direction; and
a plurality of pixels arranged in a matrix, each of the plurality of pixels including a plurality of sub-pixels, and each of the plurality of sub-pixels including:
a thin film transistor;
a pixel electrode connected to the thin film transistor; and
a common electrode that is opposed to the pixel electrode,
wherein a display region of the second substrate includes at least one layer stacked on a first surface of a second transparent substrate,
wherein the first surface of the second transparent substrate faces the first substrate, and
wherein each area defined by a boundary of each layer stacked on the first surface is larger than an area of one sub-pixel of the plurality of sub-pixels in plan view.

11. The display device of claim 10,
wherein the plurality of spacers is not integrally formed in the second substrate.

12. The display device of claim 10,
wherein the boundary of each layer is not formed in the display region of the second substrate.

13. The display device of claim 11, further comprising a liquid crystal layer,
wherein the liquid crystal layer is sandwiched between the first substrate and the second substrate.

14. The display device of claim 12,
wherein neither a light-shielding layer nor a color filter is formed in the second substrate.

15. The display device of claim 10,
wherein the display device is a curved display.
